(19) United States
(12) Patent Application Publication
(10) Pub. No.: US 2017/0145737 A1
(43) Pub. Date: May 25, 2017

(54) HEAT INSULATING FILM, MANUFACTURING METHOD OF HEAT INSULATING FILM, HEAT INSULATING GLASS, AND WINDOW

(71) Applicant: FUJIFILM Corporation, Tokyo (JP)

(72) Inventor: Kazuhiro HASEGAWA, Fujinomiya-shi (JP)

(73) Assignee: FUJIFILM Corporation, Tokyo (JP)

(21) Appl. No.: 15/422,736

(22) Filed: Feb. 2, 2017

Related U.S. Application Data
(63) Continuation of application No. PCT/JP2015/071748, filed on Jul. 31, 2015.

(30) Foreign Application Priority Data
Aug. 27, 2014 (JP) 2014-172520

(51) Int. Cl. E06B 9/24; G02B 1/14; C03C 17/42; G02B 5/20; B05D 7/00; C03C 17/32

(52) U.S. Cl. CPC E06B 9/24; B05D 7/56; C03C 17/32; C03C 17/42; G02B 5/208; G02B 1/14; E06B 2009/2417

(57) ABSTRACT

There is provided a heat insulating film including: a support; a fibrous conductive particles-containing layer; and a protective layer, in this order, in which the fibrous conductive particles-containing layer includes a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component, and fibrous conductive particles, and the protective layer includes a material having an average transmittance for far infrared rays at a wavelength of 5 μm to 10 μm in conversion of a film thickness as 20 μm which is equal to or greater than 50%, as a main component. The heat insulating film is manufactured at low cost and satisfies both of a low haze value and high heat insulating properties. A manufacturing method of a heat insulating film; a heat insulating glass; and a window are provided.

### CROSS-REFERENCE TO RELATED APPLICATIONS

This application is a Continuation of PCT International Application No. PCT/JP2015/071748, filed on Jul. 31, 2015, which claims priority under 35 U.S.C. Section 119(a) to Japanese Patent Application No. 2014-172520 filed on Aug. 27, 2014. Each of the above applications is hereby expressly incorporated by reference, in its entirety, into the present application.

### BACKGROUND OF THE INVENTION

1. Field of the Invention

The present invention relates to a heat insulating film, a manufacturing method of the heat insulating film, a heat insulating glass, and a window. More specifically, the invention relates to a heat insulating film which is manufactured at low cost and can satisfy both of a low haze value and high heat insulating properties, a manufacturing method of this heat insulating film, a heat insulating glass using this heat insulating film, and a window using this heat insulating film.

2. Description of the Related Art

In recent years, products with a lower environmental burden, which are so-called eco-friendly products have been required as one of energy saving measures for carbon dioxide reduction, and solar control films or heat insulating films for windows of vehicles or buildings have been required. The heat insulating film is a film which delays transmission and reception of heat between an indoor side and an outdoor side by being attached to windows, and usage of heating and cooling is reduced by using this film, and therefore, energy saving effects can be expected. The heat insulating properties are defined by using a coefficient of overall heat transmission. In the solar control window film procurement standard in the Law Concerning the Promotion of Procurement of Eco-Friendly Goods and Services by the State and Other Entities (so-called Green Purchasing Law), heat insulating properties are determined to be obtained when a coefficient of overall heat transmission is less than 5.9 W/(m²·K) measured by using a measurement method based on Japanese Industrial Standards (JIS) A 5759 “Films for window glasses of buildings”. When the numerical value thereof is small, the heat insulating properties are increased. According to JIS A 5759, a coefficient of overall heat transmission can be acquired from reflection spectra of far infrared rays at a wavelength of 5 μm to 50 μm. That is, it is preferable to increase reflectivity of far infrared rays at a wavelength of 5 μm to 50 μm, in order to decrease a coefficient of overall heat transmission.

As a heat insulating film, a film having a configuration of including a far infrared reflecting layer which is a laminate of metal thin film and a high refractive index film formed using vapor deposition such as a sputtering method, and a protective layer provided on the far infrared reflecting layer has been known.

JP2012-189683A, for example, discloses an infrared reflecting film including a far infrared reflecting layer having two main surfaces, a transparent film which supports one main surface of the far infrared reflecting layer and is formed of a polycycloolefin layer, and an adhesive layer which is formed on the other main surface of the far infrared reflecting layer. JP2012-189683A discloses that a reason for providing the protective layer on the far infrared reflecting layer is because scratch resistance and weather resistance are applied to the far infrared reflecting layer. JP2012-189683A discloses that the far infrared reflecting layer is a multilayer laminated film of a metal thin film formed of silver or the like and a high refractive index film formed of indium tin oxide (ITO) and is formed using vapor deposition such as a sputtering method.

JP2013-144427A discloses an infrared reflecting film obtained by laminating a reflecting layer and a protective layer, in this order on one surface of a base material, in which the protective layer is a layer including a polymer having a specific repeating unit, and an indentation hardness of the protective layer is equal to or greater than 1.2 MPa. JP2013-144427A discloses that a reason for providing the protective layer on the far infrared reflecting layer is because metals or metal oxides have low scratch resistance or because, when the infrared reflecting film is bonded to a window glass and the far infrared reflecting layer is exposed, the far infrared reflecting layer is easily damaged to cause loss of reflection characteristics of infrared light. JP2013-144427A discloses that the far infrared reflecting layer has a double-layered structure in which a translucent metal layer is interposed between a pair of metal oxide layers and is formed using vapor deposition such as a sputtering method.

However, since the metal laminates disclosed in JP2012-189683A and JP2013-144427A were manufactured by using vapor deposition such as a sputtering method, it was necessary to provide a large-scaled device such as vacuum equipment, productivity was also deteriorated, compared to that obtained using a coating method, and a manufacturing cost was high.

As a method of solving the problem regarding the manufacturing cost, a manufacturing method using a coating method by using fibrous conductive particles as a material of the heat insulating film has been known. JP2012-252172A, for example, discloses a heat ray shielding film including a transparent film and a far infrared reflecting layer provided on the surface thereof, in which the far infrared reflecting layer includes fibrous conductive particles, and that the heat ray shielding film can be manufactured using a coating method which requires a lower manufacturing cost than that in a sputtering method. According to JP2012-252172A, the far infrared reflecting layer of the heat ray shielding film includes fibrous conductive particles, and thus, excellent heat insulating properties are obtained in that heat rays of a heater or the like radiated from the indoor side are reflected to prevent radiation and outdoor heat does not enter the indoor side.

### SUMMARY OF THE INVENTION

When the inventors further investigated the heat insulating properties of the heat ray shielding film disclosed in JP2012-252172A, it was found that the heat insulating properties could be further improved. Particularly, JP2012-252172A discloses that, in the heat ray shielding film, a resin realizing great absorption of far infrared rays is used for a binder of the far infrared reflecting layer, and it was found that a configuration of significantly decreasing heat insulating properties is used.

In a case where the usage of the heat insulating film for windows of vehicles or buildings is considered, a haze value is preferably low from viewpoints of safety or comfortability. However, when the inventors investigated haze value of the heat ray shielding film disclosed in JP2012-252172A, a new problem regarding a high haze value obtained due to protrusion of fibrous conductive particles from a fibrous conductive particles-containing layer was found.

Accordingly, in the methods disclosed in JP2012-189683A, JP2013-144427A, and JP2012-252172A, a heat insulating film manufactured at low cost and satisfying both of a low haze value and high heat insulating properties has not been known.

An object of the invention is to provide a heat insulating film manufactured at low cost and satisfying both of a low haze value and high heat insulating properties.

As a result of intensive studies, the inventors have newly found that a heat insulating film manufactured at low cost and satisfying both of a low haze value and high heat insulating properties can be provided, by providing a heat insulating film in which a protective layer is provided on a fibrous conductive particles-containing layer, a material having reflectivity or transmittance for far infrared rays in a specific range is selected as a binder of the fibrous conductive particles-containing layer, and a material having transmittance for specific far infrared rays is selected as a main component of the protective layer.

That is, the invention can be achieved with the following specific means.

[1] A heat insulating film comprising:

a support;

a fibrous conductive particles-containing layer; and

a protective layer, in this order,

wherein the fibrous conductive particles-containing layer includes a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component, and fibrous conductive particles, and

the protective layer includes a material having an average transmittance for far infrared rays at a wavelength of 5 μm to 10 μm in conversion of a film thickness as 20 μm which is equal to or greater than 50%, as a main component.

[2] In the heat insulating film according to [1], it is preferable that the main component of the binder of the fibrous conductive particles-containing layer is at least one kind selected from silicon oxide, zirconium oxide, titanium oxide, and aluminum oxide.

[3] In the heat insulating film according to [1], it is preferable that the main component of the binder of the fibrous conductive particles-containing layer is a conductive polymer.

[4] In the heat insulating film according to [1], it is preferable that the main component of the binder of the fibrous conductive particles-containing layer is polycycloolefin or polyacrylonitrile.

[5] In the heat insulating film according to any one of [1] to [4], it is preferable that the main component of the protective layer is polycycloolefin or polyacrylonitrile.

[6] In the heat insulating film according to any one of [1] to [5], it is preferable that a film thickness of the protective layer is 0.1 to 5 μm.

[7] In the heat insulating film according to any one of [1] to [6], it is preferable that the main component of the protective layer is a material in which an average transmittance for far infrared rays at a wavelength of 5 μm to 10 μm in conversion of a film thickness as 20 μm is equal to or greater than 70%.

[8] In the heat insulating film according to any one of [1] to [7], it is preferable that an average long axis length of the fibrous conductive particles is 5 to 50 μm.

[9] In the heat insulating film according to any one of [1] to [8], it is preferable that the fibrous conductive particles consist of silver.

[10] In the heat insulating film according to any one of [1] to [9], it is preferable that the heat insulating film is disposed on an inner side of a window, and the fibrous conductive particles-containing layer is disposed on a surface of the support on a side opposite to the surface of the window side.

[11] A manufacturing method of a heat insulating film comprising:

applying a coating solution for forming a fibrous conductive particles-containing layer including a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component, and fibrous conductive particles, on a support to form a fibrous conductive particles-containing layer; and

applying a coating solution for forming a protective layer including a material having an average transmittance for far infrared rays at a wavelength of 5 μm to 10 μm in conversion of a film thickness as 20 μm which is equal to or greater than 50%, as a main component, on the fibrous conductive particles-containing layer to form a protective layer.

[12] A manufacturing method of a heat insulating film comprising:

applying a coating solution for forming a precursor layer including fibrous conductive particles on a support to form a precursor layer;

applying a coating solution for converting a precursor layer including a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component, on the precursor layer and causing the coating solution to permeate the precursor layer to form a fibrous conductive particles-containing layer; and

applying a coating solution for forming a protective layer including a material having an average transmittance for far infrared rays at a wavelength of 5 μm to 10 μm in conversion of a film thickness as 20 μm which is equal to or greater than 50%, as a main component, on the fibrous conductive particles-containing layer to form a protective layer.

[13] A heat insulating glass in which the heat insulating film according to any one of [1] to [10] and a glass are laminated.

[14] A window comprising:

a transparent window support; and

the heat insulating film according to any one of [1] to [10] bonded to the transparent window support.

According to the invention, it is possible to provide a heat insulating film manufactured at low cost and satisfying both of a low haze value and high heat insulating properties.

### BRIEF DESCRIPTION OF THE DRAWINGS

FIG. 1 is a schematic view showing a cross section of an example of a heat insulating film of the invention.

FIG. 2 is a schematic view showing a cross section of another example of the heat insulating film of the invention.

FIG. 3 is a schematic view showing a cross section of an example of a heat insulating glass of the invention.

### DESCRIPTION OF THE PREFERRED EMBODIMENTS

Hereinafter, the invention will be described in detail. The description of the following constituent elements is based on representative embodiments and specific examples, but the invention is not limited to such embodiments. In this specification, a number range expressed using “to” means a range including the numerical numbers before and after the term “to” as a lower limit value and an upper limit value.

In this specification, a main component of a composition means a component included in a composition having a content equal to or greater than 50% by mass with respect to the total content of the composition. A main composition of a binder, for example, means a component included in the binder having a content equal to or greater than 50% by mass with respect to the total content of the binder. A main component of a protective layer means a component included in the protective layer having a content equal to or greater than 50% by mass with respect to the total content of the protective layer.

[Heat Insulating Film]

A heat insulating film of the invention includes a support, a fibrous conductive particles-containing layer, and a protective layer, in this order, the fibrous conductive particles-containing layer includes a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component, and fibrous conductive particles, and the protective layer includes a material having an average transmittance for far infrared rays at a wavelength of 5 μm to 10 μm in conversion of a film thickness as 20 μm which is equal to or greater than 50%, as a main component. With such a configuration, it is possible to provide a heat insulating film manufactured at low cost and satisfying both of a low haze value and high heat insulating properties.

Hereinafter, the preferred aspects of the heat insulating film of the invention will be described.

<Properties>

The heat insulating film of the invention has excellent haze resistance and heat insulating properties (coefficient of overall heat transmission). The preferable ranges of the properties are the same as preferable ranges described as evaluation standard in the examples which will be described later.

In the heat insulating film of the invention, the protective layer is formed on the fibrous conductive particles-containing layer, and accordingly, it is possible to set the fibrous conductive particles not to be protruded from the surface of the heat insulating film and it is possible to decrease an external haze value while being hazed. A surface roughness of the heat insulating film of the invention (surface roughness of the protective layer) is preferably equal to or smaller than 200 nm, more preferably equal to or smaller than 100 nm, and particularly preferably 0.5 to 50 nm.

Here, the surface roughness of the protective layer is an arithmetic average roughness (Ra) of the surface of the protective layer and is based on JIS B0601. The surface roughness Ra in the invention is measured based on JIS B0601 by using a scanning probe microscope (manufactured by Seiko Instruments Inc.).

In the preferred aspect of the heat insulating film of the invention, it is preferable to further have excellent radio-wave transmittance, from a viewpoint of increasing transmittance for electric waves of a mobile phone. It is preferable that surface electrical resistance is high, from a viewpoint of radio-wave transmittance. Generally, the fibrous conductive particles-containing layer is preferably used, because the fibrous conductive particles-containing layer has higher surface electrical resistance than that of a sputtering metal laminate. When the surface electrical resistance of the fibrous conductive particles-containing layer is increased, radio-wave transmittance is further improved. The surface electrical resistance is preferably equal to or greater than 1,000Ω/□ (Ω per square), from a viewpoint of increasing radio-wave transmittance, and more preferably equal to or greater than 10,000 Ω/□.

<Configuration>

A configuration of the heat insulating film of the invention will be described.

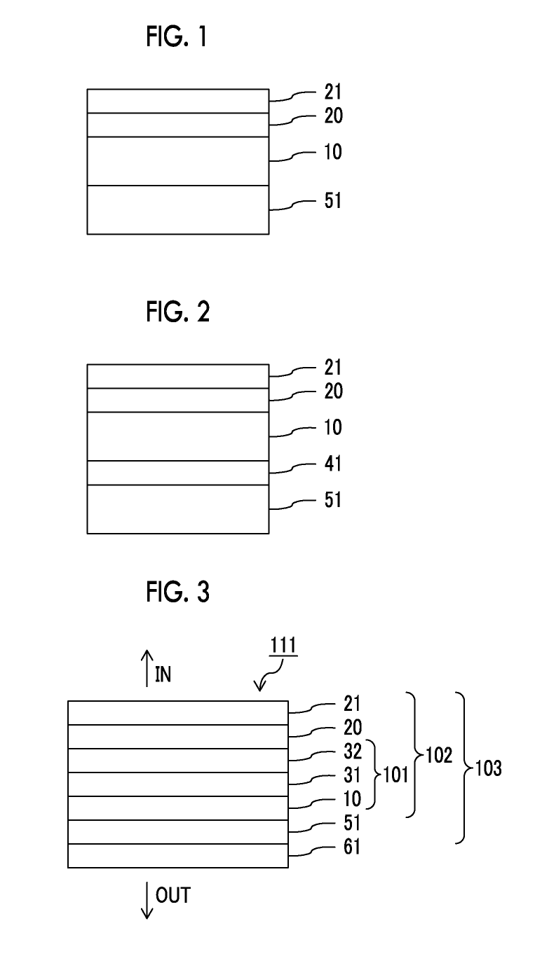

FIGS. 1 and 2 shows schematic views showing cross sections of examples of the heat insulating film of the invention. FIG. 3 shows a schematic view showing a cross section of an example of the heat insulating glass of the invention including the heat insulating film of the invention.

A heat insulating film 103 of the invention shown in FIG. 1 at least includes a support 10, a fibrous conductive particles-containing layer 20, and a protective layer 21, in this order.

The heat insulating film of the invention is preferably a heat insulating window film. It is preferable that the heat insulating film of the invention is disposed on the inner side of a window, and it is preferable that the fibrous conductive particles-containing layer 20 is disposed on a surface of the support 10 on a side opposite to a surface on a window (glass 61 in FIG. 3) side, because far infrared rays is easily reflected. When the heat insulating film is not provided, far infrared rays in a room are absorbed onto glass and the indoor heat escapes to the outside of the room due to heat conduction in the glass, but when the heat insulating film is provided, far infrared rays are reflected in the room, and accordingly, the indoor heat hardly escapes to the outside of the room. It is preferable that the protective layer 21 is an outermost layer from a viewpoint of increasing heat insulating properties of the fibrous conductive particles-containing layer 20. It is preferable that the fibrous conductive particles-containing layer 20 is a layer close to an outermost layer on the indoor side as possible, and it is preferable that the protective layer 21 is the outermost layer and the fibrous conductive particles-containing layer 20 is the second outermost layer, from a viewpoint of increasing heat insulating properties.

As shown in FIG. 1, it is preferable that the heat insulating film 103 of the invention includes a pressure sensitive adhesive layer 51 on a surface of the support 10 on the window (glass 61 in FIG. 3) side and it is preferable that the glass 61 and the pressure sensitive adhesive layer 51 are bonded to each other.

As shown in FIG. 2, it is preferable that the heat insulating film 103 of the invention includes a near infrared shielding material. In FIG. 2, an example of the heat insulating film 103 of the invention includes a near infrared shielding layer 41 including a near infrared shielding material. The near infrared shielding material may not form the near infrared shielding layer 41 alone and may be included in other layers. For example, the near infrared shielding material may be included in the fibrous conductive particles-containing layer 20, may be included in a first adhesive layer 31 or a second adhesive layer 32, or may be included in the pressure sensitive adhesive layer 51. It is preferable that the near infrared shielding material is included in a layer on a surface of the support 10 on the window (glass 61) side, from a viewpoint of shielding near infrared rays.

A heat insulating glass 111 of the invention shown in FIG. 3 includes the heat insulating film 103 of the invention and the glass 61. In a case where the glass 61 is a part of a window (window glass), it is preferable that the heat insulating film 103 of the invention is disposed on the inner side of the window (indoor side, side opposite to a sunlight incidence side during daytime, IN side in FIG. 3).

A laminate obtained by bonding the support 10, the fibrous conductive particles-containing layer 20, and the protective layer 21 through an adhesive layer may be referred to as a heat insulating member 102. The adhesive layer may be a single layer or may be a laminate of two or more layers, and the adhesive layer in FIG. 3 is a laminate of the first adhesive layer 31 and the second adhesive layer 32. In addition, a laminate obtained by providing the adhesive layer (laminate of the first adhesive layer 31 and the second adhesive layer 32 in FIG. 3) on the support 10 may be referred to as an adhesive layer-attached support 101.

Hereinafter, preferred aspect of each layer configuring the heat insulating film of the invention will be described.

<Support>

Various elements can be used as the support described above according to the purpose, as long as it can support the fibrous conductive particles-containing layer. Generally, a plate-shaped or a sheet-shaped material is used.

The support may be transparent or may be opaque, but the support is preferably transparent and more preferably transparent for visible light. Visible light transmittance of the support is preferably equal to or greater than 70%, more preferably equal to or greater than 85%, and even more preferably equal to or greater than 90%. The visible light transmittance of the support is measured based on International Organization for Standardization (ISO) 13468-1 (1996).

Examples of a material configuring the support include a synthetic resin such as polycarbonate, polyether sulfone, polyester, an acrylic resin, a vinyl chloride resin, an aromatic polyamide resin, polyamide imide, polyimide, polyethylene terephthalate, or a polycycloolefin. The surface of the support where the fibrous conductive particles-containing layer is formed may be previously treated by purification treatment using an alkaline aqueous solution, chemical treatment using a silane coupling agent, plasma treatment, ion plating, sputtering, a gas phase reaction method, and vacuum evaporation, if desired.

A thickness of the support is in a desired range according to the purpose. In general, the thickness thereof is selected from a range of 1 μm to 500 μm, is more preferably 3 μm to 400 μm, and even more preferably 5 μm to 300 μm.

<Fibrous Conductive Particles-Containing Layer>

The fibrous conductive particles-containing layer includes a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component, and fibrous conductive particles.

In the fibrous conductive particles-containing layer, a void size thereof is preferably small, in order to reflect far infrared rays. In a cross section of the fibrous conductive particles-containing layer, for example, it is more preferable that 80% or more voids have a void area of 25 (μm)² or less.

(Fibrous Conductive Particles)

The fibrous conductive particles have a fibrous shape and the fibrous shape has the same meaning as a wire shape or a liner shape.

The fibrous conductive particles have conductivity.

As the fibrous conductive particles, metal nanowires, rod-shaped metal particles, or carbon nanotubes can be used. Metal nanowires are preferable as the fibrous conductive particles. Hereinafter, the metal nanowires will be described as a representative example of the fibrous conductive particles, but the description of the metal nanowires can be used as general description of the fibrous conductive particles.

The fibrous conductive particles-containing layer preferably contains metal nanowires having an average short axis length equal to or smaller than 150 nm as fibrous conductive particles. The average short axis length is preferably equal to or smaller than 150 nm, because heat insulating properties are improved and optical characteristics are hardly deteriorated due to light scattering. The fibrous conductive particles such as metal nanowires preferably have a solid structure.

In order to easily form more transparent fibrous conductive particles-containing layer, fibrous conductive particles having an average short axis length of 1 nm to 150 nm are preferable, for example, as the fibrous conductive particles such as metal nanowires.

From easiness of handling at the time of the manufacturing, an average short axis length (average diameter) of the fibrous conductive particles such as metal nanowires is preferably equal to or smaller than 100 nm, more preferably equal to or smaller than 60 nm, and even more preferably equal to or smaller than 50 nm, and the average short axis length thereof is particularly equal to or smaller than 25 nm, because more excellent properties with respect to haze are obtained. When the average short axis length thereof is equal to or greater than 1 nm, a fibrous conductive particles-containing layer having excellent oxidation resistance and excellent weather resistance. The average short axis length thereof is more preferably equal to or greater than 5 nm, even more preferably equal to or greater than 10 nm, and particularly preferably equal to or greater than 15 nm.

The average long axis length of the fibrous conductive particles such as metal nanowires is preferably the same as a wavelength in a reflection band of far infrared rays desired to be reflected, in order to easily perform reflection in the reflection band of far infrared rays desired to be reflected. The average long axis length of the fibrous conductive particles such as metal nanowires is preferably 5 μm to 50 μm, in order to easily reflect far infrared rays at a wavelength of 5 to 50 μm, more preferably 10 μm to 40 μm, and even more preferably 15 μm to 40 μm. When the average long axis length of the metal nanowires is equal to or smaller than 40 μm, synthesis of metal nanowires is easily performed without generating aggregates, and when the average long axis length thereof is equal to or greater than 15 μm, sufficient heat insulating properties are easily obtained.

The average short axis length (average diameter) and the average long axis length of fibrous conductive particles such as metal nanowires can be acquired by observing a transmission electron microscope (TEM) image or an optical microscope image by using a TEM and an optical microscope, for example. Specifically, regarding the average short axis length (average diameter) and the average long axis length of fibrous conductive particles such as metal nanowires, short axis lengths and long axis lengths of 300 metal nanowires randomly selected are measured by using a transmission electron microscope (JEOL, Ltd., product name: JEM-2000FX) and the average short axis length and the average long axis length of fibrous conductive particles such as metal nanowires can be acquired from the average values thereof. In this specification, the values obtained by using this method are used. Regarding the short axis length in a case where a cross section of the metal nanowires in a short axis direction does not have a circular shape, a length of the longest portion obtained by measuring a length in a short axis direction is set as the short axis length. In addition, in a case where the fibrous conductive particles such as metal nanowires are curved, a circle having the curved shape as an arc is considered, and a value calculated from the radius thereof and curvature is set as the long axis length.

In the embodiment, a content of fibrous conductive particles such as metal nanowires having a short axis length (diameter) equal to or smaller than 150 nm and a long axis length of 5 μm to 50 μm with respect to a content of fibrous conductive particles such as the entire metal nanowires of the fibrous conductive particles-containing layer is preferably equal to or greater than 50% by mass, more preferably equal to or greater than 60% by mass, and even more preferably equal to or greater than 75% by mass, in terms of the metal amount.

It is preferable that a percentage of the fibrous conductive particles such as metal nanowires having a short axis length (diameter) equal to or smaller than 150 nm and a length of 5 μm to 50 μm is equal to or greater than 50% by mass, because sufficient heat insulating properties are obtained and a decrease in haze due to particles having a great short axis length or particles having a small length is prevented. In a configuration in which conductive particles other than the fibrous conductive particles are not substantially included in the fibrous conductive particles-containing layer, a decrease in transparency can be avoided, even in a case of strong plasmon absorption.

A coefficient of variation of the short axis lengths (diameters) of the fibrous conductive particles such as metal nanowires used in the fibrous conductive particles-containing layer is preferably equal to or smaller than 40%, more preferably equal to or smaller than 35%, and even more preferably equal to or smaller than 30%.

The coefficient of variation is preferably equal to or smaller than 40%, from a viewpoint of transparency and heat insulating properties, because a proportion of metal nanowires which easily reflect far infrared rays at a wavelength of 5 to 50 μm is increased.

The coefficient of variation of the short axis lengths (diameters) of the fibrous conductive particles such as metal nanowires can be acquired by measuring short axis lengths (diameters) of 300 nanowires randomly selected from a transmission electron microscope (TEM), for example, calculating a standard deviation and an arithmetic mean value thereof, and dividing the standard deviation by the arithmetic mean value.

An aspect ratio of the fibrous conductive particles such as metal nanowires used in the invention is preferably equal to or greater than 10. Here, the aspect ratio means a ratio of the average long axis length to the average short axis length (average long axis length/average short axis length). The aspect ratio can be calculated from the average long axis length and the average short axis length calculated by using the method described above.

The aspect ratio of the fibrous conductive particles such as metal nanowires is not particularly limited, as long as it is equal to or greater than 10. The aspect ratio thereof can be suitably selected according to the purpose, and is preferably 10 to 100,000, more preferably 50 to 100,000, and even more preferably 100 to 100,000.

When the aspect ratio is equal to or greater than 10, a network in which the fibrous conductive particles such as metal nanowires are evenly dispersed is easily formed, and a fibrous conductive particles-containing layer having high heat insulating properties is easily obtained. When the aspect ratio is equal to or smaller than 100,000, formation of aggregates due to a tangle of the fibrous conductive particles such as metal nanowires in a coating solution used when providing the fibrous conductive particles-containing layer on the support by coating, for example, and a stable coating solution is obtained, and accordingly, the fibrous conductive particles-containing layer is easily manufactured.

The content of the fibrous conductive particles such as metal nanowires having an aspect ratio equal to or greater than 10 with respect to the mass of the fibrous conductive particles such as the entire metal nanowires included in the fibrous conductive particles-containing layer is not particularly limited. The content is, for example, preferably equal to or greater than 70% by mass, more preferably equal to or greater than 75% by mass, and most preferably equal to or greater than 80% by mass.

A shape of the fibrous conductive particles such as metal nanowires may be arbitrary shapes such as a cylindrical shape, a rectangular parallelepiped shape, or a columnar shape having a polygonal cross section. When a high transparency is necessary, a cylindrical shape or a polygonal shape having a pentagonal or more polygonal cross section and having a cross sectional shape without a sharp-pointed angle is preferable.

The cross sectional shape of the fibrous conductive particles such as metal nanowires can be detected by applying a fibrous conductive particles aqueous dispersion such as metal nanowires on a support and observing a cross section with a transmission electron microscope (TEM).

The metal for forming the fibrous conductive particles such as metal nanowires is not particularly limited and any metal may be used. In addition to one kind of metal, a combination of two or more kinds of metal may be used and an alloy thereof can be used. Among these, the metal is preferably formed of a metal alone or a metal compound, and the metal is more preferably formed of a metal alone.

As the metal, at least one kind of metal selected from the group consisting metals of fourth, fifth, and sixth period in a long-form periodic table (International Union of Pure and applied Chemistry (IUPAC) 1991) is preferable, at least one kind of metal selected from second to fourteenth groups is more preferable, at least one kind of metal selected from the second group, the eighth group, the ninth group, the tenth group, the eleventh group, the twelfth group, the thirteenth group, and the fourteenth group is even more preferable, and it is particularly preferable that these metals are contained as a main component.

Specific examples of the metal include copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead, and an alloy containing any one of these. Among these, copper, silver, gold, platinum, palladium, nickel, tin, cobalt, rhodium, iridium, or an alloy thereof is preferable, palladium, copper, silver, gold, platinum, tin, or an alloy of any one of these is more preferable, and silver or an alloy containing silver is particularly preferable. Here, a content of silver in an alloy containing silver is preferably equal to or greater than 50 mol %, more preferably equal to or greater than 60 mol %, and even more preferably equal to or greater than 80 mol % with respect to the entire quantity of the alloy.

The content of silver nanowires with respect to the mass of the fibrous conductive particles such as the entire metal nanowires included in the fibrous conductive particles-containing layer is not particularly limited, as long as it does not disturb the effects of the invention. The content of silver nanowires with respect to the mass of the fibrous conductive particles such as the entire metal nanowires included in the fibrous conductive particles-containing layer is, for example, preferably equal to or greater than 50% by mass and more preferably equal to or greater than 80% by mass, and it is even more preferable that the fibrous conductive particles such as the entire metal nanowires are substantially silver nanowires. Here, the term “substantially” means that inevitably mixed metal atoms other than silver are accepted.

The mass per unit area of the fibrous conductive particles-containing layer (coating amount of total solid contents of a coating solution at the time of preparing a film) is selected so that the heat insulating properties, visible transmittance, and a haze value of the fibrous conductive particles-containing layer are in desired ranges. When the coating amount is excessively small, sufficient heat insulating properties are not obtained, and when the coating amount is excessively great, this causes an increase in a haze value or causes cracks or peeling of the fibrous conductive particles-containing layer. The mass per unit area thereof is preferably in a range of 0.050 to 1.000 g/m², more preferably in a range of 0.100 to 0.600 g/m², and particularly preferably in a range of 0.110 to 0.500 g/m².

The amount of fibrous conductive particles with respect to the fibrous conductive particles-containing layer is selected so that the heat insulating properties, visible transmittance, and a haze value of the fibrous conductive particles-containing layer are in desired ranges. When the amount of the fibrous conductive particles is excessively small, sufficient heat insulating properties are not obtained, and when the amount thereof is excessively great, this causes an increase in a haze value or causes a decrease in radio-wave transmittance of the fibrous conductive particles-containing layer. The amount thereof is preferably 1% to 65% by mass, more preferably 3% to 50% by mass, and particularly preferably 5% to 35% by mass.

—Manufacturing Method of Fibrous Conductive Particles—

The fibrous conductive particles such as metal nanowires are not particularly limited and may be manufactured by any method. As will be described below, it is preferable that the fibrous conductive particles are manufactured by reducing metal ions in a solvent obtained by dissolving a halogen compound and a dispersing agent. After fibrous conductive particles such as metal nanowires are formed, desalinization treatment is performed in a routine procedure, and this operation is preferable from viewpoints of dispersibility and temporal stability of the fibrous conductive particles-containing layer.

As the manufacturing method of the fibrous conductive particles such as metal nanowires, methods disclosed in JP2009-215594A, JP2009-242880A, JP2009-299162A, JP2010-84173A, and JP2010-86714 can be used.

As a solvent used in the manufacturing of the fibrous conductive particles such as metal nanowires, a hydrophilic solvent is preferable, and examples thereof include water, an alcohol solvent, an ether solvent, and a ketone solvent. These may be used alone or in combination of two or more kinds thereof.

Examples of the alcohol solvent include methanol, ethanol, propanol, isopropanol, butanol, and ethylene glycol.

Examples of the ether solvent include dioxane and tetrahydrofuran.

Examples of the ketone solvent include acetone and the like.

In a case of performing heating, a heating temperature thereof is preferably equal to or lower than 250° C., more preferably 20° C. to 200° C., even more preferably 30° C. to 180° C., and particularly preferably 40° C. to 170° C. When the temperature is equal to or higher than 20° C., a length of the fibrous conductive particles such as metal nanowires formed is in a preferable range so as to ensure dispersion stability, and when the temperature is equal to or lower than 250° C., the periphery of the cross section of the metal nanowires has a smooth shape without acute angles, and accordingly, coloration due to surface plasmon absorption of the metal particles is prevented. Therefore, the range thereof is preferable from a viewpoint of transparency.

The temperature may be changed during a particle formation process, if necessary, and the temperature change during the process may have effects of control of nucleus formation or prevention of regeneration of nucleus, and improvement of monodispersity due to improvement of selective growth.

The heating process is preferably performed by adding a reducing agent.

The reducing agent is not particularly limited and can be suitably selected from elements normally used. Examples thereof include borohydride metal salt, aluminum hydride salt, alkanolamine, aliphatic amine, heterocyclic amine, aromatic amine, aralkyl amine, alcohols, organic acids, reducing sugars, sugar alcohols, sodium sulfite, hydrazine compounds, dextrin, hydroquinone, hydroxylamine, ethylene glycol, and glutathione. Among these, reducing sugars, sugar alcohols as a derivative thereof, and ethylene glycol are particularly preferable.

As a reducing agent, a compound having a function as both of a dispersing agent or a solvent can be preferably used, in the same manner.

The fibrous conductive particles such as metal nanowires are preferably manufactured by adding a dispersing agent and halogen compounds or metal halide fine particles.

The timing of adding a dispersing agent and halogen compounds may be before adding a reducing agent or after adding a reducing agent or may be before adding metal ions or metal halide fine particles or after adding metal ions or metal halide fine particles. In order to obtain fibrous conductive particles having better monodispersity, the adding of halogen compounds is preferably divided into two or more steps, because nucleus formation and growth can be controlled.

The step of adding a dispersing agent is not particularly limited. A dispersing agent may be added before preparing the fibrous conductive particles such as metal nanowires and the fibrous conductive particles such as metal nanowires may be added under the presence of the dispersing agent, or a dispersing agent may be added after preparing the fibrous conductive particles such as metal nanowires, in order to control a dispersion state.

Examples of the dispersing agent include an amino group-containing compound, a thiol group-containing compound, a sulfide group-containing compound, amino acid or a derivative thereof, a peptide compounds, polysaccharides, a polysaccharides-derived natural polymer, a synthetic polymer, and polymer compounds such as gel derived therefrom. Among these, various polymer compounds preferably used as a dispersing agent are compounds included in polymers which will be described below.

Preferable examples of polymers used as a dispersing agent include polymers including a hydrophilic group such as gelatin, polyvinyl alcohol, methyl cellulose, hydroxypropyl cellulose, polyalkylene amine, partial alkyl ester of polyacrylic acid, polyvinyl pyrrolidone, a copolymer having a polyvinyl pyrrolidone structure, and polyacrylic acid having an amino group or a thiol group which are protective colloid polymers.

A weight average molecular weight (Mw) of the polymer used as a dispersing agent measured by using gel permeation chromatography (GPC) is preferably 3,000 to 300,000 and more preferably 5,000 to 100,000.

The description in “Genryo No Jiten” (edited by Seijiro Ito, published by Asakura Publishing, 2000) can be referred for the structure of a compound capable of being used as a dispersing agent.

A shape of metal nanowires obtained can be changed depending on the kind of a dispersing agent used.

The halogen compound is not particularly limited, as long as it is a compound containing bromine, chlorine, and iodine, and can be suitably selected according to the purpose. Preferable examples thereof include alkali halide such as sodium bromide, sodium chloride, sodium iodide, potassium iodide, potassium bromide, or potassium chloride, or a compound capable of being used in combination with the following dispersion additive.

The halogen compound may function as a dispersion additive and the dispersion additive can be preferably used in the same manner.

Silver halide fine particles may be used as a substitute of the halogen compound, or a halogen compound and silver halide fine particles may be used in combination.

In addition, a single substance having both a function of a dispersing agent and a function of a halogen compound may be used. That is, both functions of a dispersing agent and a halogen compound are realized with one compound, by using a halogen compound having a function as a dispersing agent.

Examples of the halogen compound having a function as a dispersing agent include hexadecyl-trimethyl ammonium bromide containing an amino group and bromide ions, hexadecyl-trimethyl ammonium chloride containing an amino group and chloride ions, dodecyltrimethylammonium bromide containing an amino group and bromide ions or chloride ions, dodecyltrimethylammonium chloride, stearyltrimethylammonium bromide, stearyltrimethylammonium chloride, decyltrimethylammonium bromide, decyltrimethylammonium chloride, dimethyldistearylammonium bromide, dimethyldistearylammonium chloride, dilauryldimethylammonium bromide, dilauryldimethylammonium chloride, dimethyldipalmitylammonium bromide, and dimethyldipalmitylammonium chloride.

In the manufacturing method of the fibrous conductive particles such as the metal nanowires, it is preferable to perform desalinization treatment after forming the fibrous conductive particles such as the metal nanowires. The desalinization treatment after forming the fibrous conductive particles such as metal nanowires can be performed by using methods such as ultrafiltration, dialysis, gel filtration, decantation, and centrifugal separation.

It is preferable that the fibrous conductive particles such as metal nanowires do not contain inorganic ions such as alkali metal ions, alkali earth metal ions, and halide ions, if possible. Electric conductivity of a dispersed material obtained by dispersing metal nanowires in an aqueous solvent is preferably equal to or smaller than 1 mS/cm, more preferably equal to or smaller than 0.1 mS/cm, and even more preferably equal to or smaller than 0.05 mS/cm.

Viscosity of the aqueous dispersed material of the fibrous conductive particles such as metal nanowires at 25° C. is preferably 0.5 mPa·s to 100 mPa·s and more preferably 1 mPa·s to 50 mPa·s.

The electric conductivity and the viscosity are measured by setting concentration of the fibrous conductive particles such as metal nanowires in the aqueous dispersed material as 0.45% by mass. In a case where the concentration of the fibrous conductive particles such as metal nanowires in the aqueous dispersed material is higher than the above-mentioned concentration, the measurement is performed by diluting the aqueous dispersed material with a distilled water.

(Binder)

The fibrous conductive particles-containing layer includes a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component.

By including the binder, the dispersed state of the fibrous conductive particles such as the metal nanowires of the fibrous conductive particles-containing layer is stably maintained and, even in a case where the fibrous conductive particles-containing layer is formed on the surface of the support without using an adhesive layer, the strong adhesiveness between the support and the fibrous conductive particles-containing layer tends to be ensured. In the invention, it is possible to increase heat insulating properties of the heat insulating film by using the binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component.

The fibrous conductive particles-containing layer may include a matrix other than the binder described above. The “matrix” here is a general term of substances which form a layer including the fibrous conductive particles such as metal nanowires.

The binder of the fibrous conductive particles-containing layer includes a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component (includes 50% by mass or more of the material). The content of a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50% is preferably equal to or greater than 70% by mass, more preferably equal to or greater than 90% by mass, and particularly preferably 100% by mass.

—Material Having Maximum Peak Value of Reflectivity for Far Infrared rays at Wavelength of 5 to 25 μm Which is Equal to or Greater Than 20%—

In the material having a maximum peak value of reflectivity for far infrared rays at a wavelength of 5 to 25 μm which is equal to or greater than 20% which is used as the binder of the fibrous conductive particles-containing layer, the maximum peak value of reflectivity for far infrared rays at a wavelength of 5 to 25 μm is preferably equal to or greater than 23%, more preferably equal to or greater than 25%, and particularly preferably equal to or greater than 27%.

As the material having a maximum peak value of reflectivity for far infrared rays at a wavelength of 5 to 25 μm which is equal to or greater than 20%, a sol-gel hardened material obtained by hydrolysis and polycondensation of an alkoxide compound of an element (b) selected from the group consisting of Si, Ti, Zr, and Al, or a conductive polymer can be used. Hereinafter, the preferred aspect of the sol-gel hardened material and the conductive polymer will be described.

—Sol-Gel Hardened Material—

In the heat insulating film of the invention, the main component of the binder of the fibrous conductive particles-containing layer preferably includes a sol-gel hardened material obtained by hydrolysis and polycondensation of an alkoxide compound of an element (b) selected from the group consisting of Si, Ti, Zr, and Al, and particularly preferably a sol-gel hardened material obtained by hydrolysis and polycondensation of an alkoxide compound of the Si element, from viewpoints of the manufacturing cost and the reflectivity in a far infrared region.

The sol-gel hardened material obtained by hydrolysis and polycondensation of an alkoxide compound (hereinafter, also referred to as a specific alkoxide compound) of an element (b) selected from the group consisting of Si, Ti, Zr, and Al is at least one kind selected from silicon oxide, zirconium oxide, titanium oxide, and aluminum oxide. In a case where the main component of the binder of the fibrous conductive particles-containing layer is the sol-gel hardened material obtained by hydrolysis and polycondensation of an alkoxide compound of an element (b) selected from the group consisting of Si, Ti, Zr, and Al, the main component of the binder of the fibrous conductive particles-containing layer is at least one kind selected from silicon oxide, zirconium oxide, titanium oxide, and aluminum oxide.

The fibrous conductive particles-containing layer preferably satisfies at least one of the following condition (i) or (ii), more preferably satisfies at least the following conditions (ii), and particularly preferably satisfies the following conditions (i) and (ii).

(i) A ratio of substance quantity of the element (b) included in the fibrous conductive particles-containing layer and substance quantity of the metal element (a) included in the fibrous conductive particles-containing layer [molar number of (element (b))/molar number of (metal element (a))] is in a range of 0.10/1 to 22/1.

(ii) A ratio of a mass of the alkoxide compound used for forming the sol-gel hardened material in the fibrous conductive particles-containing layer to a mass the fibrous conductive particles such as metal nanowires included in the fibrous conductive particles-containing layer [(content of alkoxide compound)/(content of the fibrous conductive particles such as metal nanowires)] is in a range of 0.25/1 to 30/1.

It is preferable that the fibrous conductive particles-containing layer is formed so that a ratio of a usage amount of a specified alkoxide compound with respect to a usage amount of the fibrous conductive particles such as metal nanowires, that is, a ratio of [(mass of specified alkoxide compound)/(mass of the fibrous conductive particles such as metal nanowires)] is in a range of 0.25/1 to 30/1. In a case where the mass ratio is equal to or greater than 0.25/1, it is possible to obtain a fibrous conductive particles-containing layer having excellent heat insulating properties (this may be due to high conductivity of the fibrous conductive particles) and transparency, and excellent abrasion resistance, heat resistance, moisture-heat resistance, and bending resistance. In a case where the mass ratio is equal to or smaller than 30/1, it is possible to obtain a fibrous conductive particles-containing layer having excellent conductivity and bending resistance.

The mass ratio is more preferably in a range of 0.5/1 to 25/1, even more preferably in a range of 1/1 to 20/1, and most preferably in a range of 2/1 to 15/1. By setting the mass ratio to be in the preferable range, the fibrous conductive particles-containing layer obtained has high heat insulating properties and high transparency (visible light transmittance and haze), and excellent abrasion resistance, heat resistance, moisture-heat resistance, and bending resistance, and accordingly, it is possible to stably obtain a heat insulating film having suitable physical properties.

—Conductive Polymer—

In the heat insulating film of the invention, it is preferable that the main component of the binder of the fibrous conductive particles-containing layer is a conductive polymer. The conductive polymer also effectively shields infrared light and exhibits heat insulating properties. This is thought because a plasma absorption wavelength obtained due to free electrons of the conductive polymer is on a side of a short wavelength than that in radiation of an object at a temperature close to a ground temperature, and electromagnetic waves at a higher wavelength than the plasma absorption wavelength is reflected.

As the conductive polymer used as the main component of the binder of the fibrous conductive particles-containing layer, conductive polymers disclosed in paragraphs “0038” to “0046” and examples of JP2012-189683A can be preferably used. Specifically, the conductive polymer is normally an organic polymer having a conjugate type double bond as a basic structure, and specifically, polythiophene, polypyrrole, polyaniline, polyacetylene, polyparaphenylene, polyfuran, polyfluorene, polyphenylene vinylene, a derivative thereof, and a mixture of one kind or two or more kinds of conductive polymers selected from copolymers of monomers configuring these are preferably used. Among these, a polythiophene derivative which has solubility or dispersibility with respect to water or other solvents and has high conductivity and transparency is preferable.

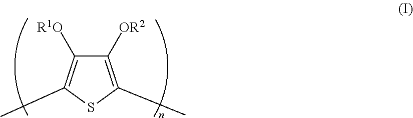

Particularly, a polythiophene derivative having a repeating unit expressed by Formula (I) (in the formula, R¹ and R² each independently represent a hydrogen atom or an alkyl group having 1 to 4 carbon atoms or R¹ and R² may be bonded to each other to form an alkylene group having 1 to 4 carbon atoms that may be arbitrarily substituted, and n represents an integer of 50 to 1,000) is preferable.

In Formula (I), as an alkylene group having 1 to 4 carbon atoms that may be substituted, which is formed by bonding R¹ and R² to each other, specifically, a methylene group substituted with an alkyl group, a group for forming an ethylene-1,2 group, a propylene-1,3 group, and a butene-1,4 group arbitrarily substituted with an alkyl group or a phenyl group having 1 to 12 carbon atoms are used.

As R¹ and R² of Formula (I), a methyl group or an ethyl group, or a methylene group, an ethylene-1,2 group, or a propylene-1,3 group formed by bonding R¹ and R² to each other is used.

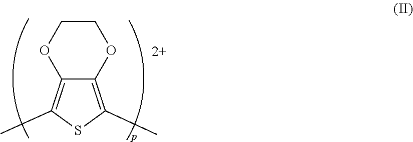

Particularly, as a preferable polythiophene derivative, a polythiophene derivative having a repeating unit, that is, a poly(3,4-ethylenedioxythiophene) unit represented by Formula (II) (in the formula, p represents an integer of 50 to 1,000) is used.

The conductive polymer preferably further includes a dopant (electron donor). Preferable examples of the dopant include polystyrene sulfonate, polyacrylic acid, polymethacrylic acid, polymaleic acid, and polyvinyl sulfonate. Particularly, polystyrene sulfonate is preferable. With these elements, it is possible to improve conductivity of the conductive polymer and to increase heat insulating properties of the fibrous conductive particles-containing layer. A number average molecular weight Mn of the dopant is preferably 1,000 to 2,000,000 and particularly preferably 2,000 to 500,000.

The content of the dopant is normally 20 to 2,000 parts by mass and preferably 40 to 200 parts by mass with respect to 100 parts by mass of the conductive polymer. For example, in a case where the polythiophene derivative of Formula (II) is used as the conductive polymer and polystyrene sulfonate is used as the dopant, the content of polystyrene sulfonate is preferably 100 to 200 parts by mass and particularly 120 to 180 parts by mass with respect to 100 parts by mass of polythiophene.

—Material Having Average Transmittance for Far Infrared Rays at Wavelength of 5 μm to 10 μm Which is Equal to or Greater Than 50% in Conversion of Film Thickness as 20 μm—

In the material having an average transmittance for far infrared rays at a wavelength of 5 μm to 10 μm in conversion of a film thickness as 20 μm which is equal to or greater than 50% which is used as the binder of the fibrous conductive particles-containing layer, the average transmittance for far infrared rays at a wavelength of 5 μm to 10 μm in conversion of a film thickness as 20 μm is preferably equal to or greater than 60%, more preferably equal to or greater than 70%, and particularly preferably equal to or greater than 80%.

As the material having an average transmittance for far infrared rays at a wavelength of 5 μm to 10 μm in conversion of a film thickness as 20 μm which is equal to or greater than 50%, a polymer material having high proportions of carbon atoms, nitrogen atoms, and hydrogen atoms and a low proportion of oxygen molecules is preferable, a polymer material not including oxygen molecules is more preferable, and polycycloolefin or polyacrylonitrile is particularly preferable. That is, in the heat insulating film of the invention, the main component of the binder of the fibrous conductive particles-containing layer is preferably polycycloolefin or polyacrylonitrile.

In this specification, “polycycloolefin” is a polymer or a copolymer obtained by using an alicyclic compound having a double bond. A polycycloolefin layer has a basic structure configured with carbon atoms and hydrogen atoms, and accordingly, stretching vibration of a C—H group occurs on a side of a short wavelength (mid-infrared region) of infrared light, and a degree of absorption in a far infrared region is small. Accordingly, it is possible to increase average transmittance of far infrared rays at a wavelength of 5 μm to 10 μm in conversion of a film thickness as 20 μm (for example, equal to or greater than 50%).

As polycycloolefin used as the main component of the binder of the fibrous conductive particles-containing layer, a material of a transparent film disclosed in paragraphs “0020” to “0022” and examples of JP2012-189683A can be preferably used. Specifically, polycycloolefin used as the main component of the binder of the fibrous conductive particles-containing layer is preferably polynorbornene. Polynorbornene is hardly absorbed in an infrared region and has excellent heat insulating properties and weather resistance. As polynorbornene, a commercially available product (for example, ZEONEX or ZEONOR manufactured by Zeon Corporation) may be used.

As polyacrylonitrile used as the main component of the binder of the fibrous conductive particles-containing layer, a monomer of polyacrylonitrile may be used or a copolymer of polyacrylonitrile and other repeating units may be used within a range not departing the gist of the invention.

As polyacrylonitrile used as the main component of the binder of the fibrous conductive particles-containing layer, a material of a protective layer disclosed in paragraphs “0020” to “0041” and examples of JP2013-144427A can be preferably used.

As polyacrylonitrile, a commercially available product may be used. For example, completely hydrogenated nitrile rubber (product name: THERBAN 5005, THERBAN 3047, all manufactured by LANXESS), hydrogenated nitrile rubber (product name: THERBAN 5065, THERBAN 4367, and 3496, all manufactured by LANXESS), acrylonitrile-butadiene rubber (product name: N22L manufactured by JSR Corporation) may be used.

—Other Matrix—

The material having a maximum peak value of reflectivity for far infrared rays at a wavelength of 5 to 25 μm which is equal to or greater than 20% or the material having an average transmittance for far infrared rays at a wavelength of 5 μm to 10 μm in conversion of a film thickness as 20 μm which is equal to or greater than 50% included in the fibrous conductive particles-containing layer has a function as a matrix, but the fibrous conductive particles-containing layer may further include matrix other than the material having a maximum peak value of reflectivity for far infrared rays at a wavelength of 5 to 25 μm which is equal to or greater than 20% or the material having an average transmittance for far infrared rays at a wavelength of 5 μm to 10 μm in conversion of a film thickness as 20 μm which is equal to or greater than 50% (hereinafter, referred to as other matrix). The fibrous conductive particles-containing layer containing other matrix contains a material capable of forming other matrix in a liquid composition which will be described later, and may be formed by applying this on the support.

The other matrix may be nonphotosensitive such as an organic polymer or may be photosensitive such as a photoresist composition.

In a case where the fibrous conductive particles-containing layer includes other matrix, the content thereof is selected from a range of 0.10% by mass to 20% by mass, preferably selected from a range of 0.15% by mass to 10% by mass, and even more preferably selected from a range of 0.20% by mass to 5% by mass, with respect to the content of the material having a maximum peak value of reflectivity for far infrared rays at a wavelength of 5 to 25 μm which is equal to or greater than 20% or the material having an average transmittance for far infrared rays at a wavelength of 5 μm to 10 μm in conversion of a film thickness as 20 μm which is equal to or greater than 50% included in the fibrous conductive particles-containing layer, because a fibrous conductive particles-containing layer having excellent heat insulating properties, transparency, film hardness, abrasion resistance, and bending resistance is obtained.

—Dispersing Agent—

A dispersing agent is used for dispersing the fibrous conductive particles such as metal nanowires in the photopolymerizable composition while preventing aggregation thereof. The dispersing agent is not particularly limited as long as it can disperse metal nanowires and can be suitably selected according to the purpose. For example, a dispersing agent which is commercially available as a pigment dispersing agent can be used, and it is preferable to use particularly a polymer dispersing agent having properties of being adsorbed to metal wires. Examples of such a polymer dispersing agent include polyvinylpyrrolidone, BYK SERIES (registered trademark, manufactured by BYK Additives & Instruments), SOLSPERSE SERIES (manufactured by The Lubrizol Corporation), and AJISPER SERIES (manufactured by Ajinomoto Co., Inc.).

The content of the dispersing agent in the fibrous conductive particles-containing layer is preferably 0.1 parts by mass to 50 parts by mass, more preferably 0.5 parts by mass to 40 parts by mass, and particularly preferably 1 part by mass to 30 parts by mass, with respect to 100 parts by mass of a binder in a case of using a binder disclosed in paragraphs “0086” to “0095” of JP2013-225461A.

When the content of the dispersing agent with respect to the binder is equal to or greater than 0.1 parts by mass, aggregation of the fibrous conductive particles such as metal nanowires in a dispersion is effectively prevented, and when the content thereof is equal to or smaller than 50 parts by mass, a stable liquid film is formed in a coating step and generation of coating unevenness is prevented, and thus, the ranges described above are preferable.

—Solvent—

A solvent is a component used for preparing a coating solution for forming a composition including the fibrous conductive particles such as metal nanowires, and the binder including the material having a maximum peak value of reflectivity for far infrared rays at a wavelength of 5 to 25 μm which is equal to or greater than 20% or the material having an average transmittance for far infrared rays at a wavelength of 5 μm to 10 μm in conversion of a film thickness as 20 μm which is equal to or greater than 50%, as a main component, on the surface of the support or a surface of an adhesive layer of an adhesive layer-attached support to have a film shape, and can be suitably selected according to the purpose. The solvent may be any solvent as long as it can dissolve 0.1% by mass or more of the binder and examples thereof include water, an alcoholic solvent, a ketone-based solvent, an ether-based solvent, a hydrocarbon-based solvent, an aromatic solvent, and a halogen solvent. This solvent may serve as at least some of the solvent of the dispersion of the metal nanowires described above. These may be used alone or in combination of two or more kinds thereof.

A solid content concentration of the coating solution containing the solvent is preferably in a range of 0.1% by mass to 20% by mass.

—Metal Corrosion Inhibitor—

The fibrous conductive particles-containing layer preferably contains a metal corrosion inhibitor of the fibrous conductive particles such as metal nanowires. The metal corrosion inhibitor is not particularly limited and can be suitably selected according to the purposes. Thiols or azoles are suitable, for example.

When the metal corrosion inhibitor is contained, it is possible to exhibit an antirust effect and to prevent a decrease in heat insulating properties and transparency of the fibrous conductive particles-containing layer over time. The metal corrosion inhibitor can be applied by being added into a composition for forming the fibrous conductive particles-containing layer in a state of being suitably dissolved with a solvent or in a state of powder, or manufacturing a conductive film using a coating solution for a conductive layer which will be described later and then dipping the conductive film in a metal corrosion inhibitor bath.

In a case of adding the metal corrosion inhibitor, the content thereof in the fibrous conductive particles-containing layer is preferably 0.5% by mass to 10% by mass with respect to the content of the fibrous conductive particles such as metal nanowires.

As the other matrix, the polymer compound of the dispersing agent used when preparing the fibrous conductive particles such as metal nanowires described above can be used as at least a part of components configuring the matrix.

—Other Conductive Material—

The fibrous conductive particles-containing layer may include other conductive materials, for example, conductive particles, in addition to the fibrous conductive particles such as metal nanowires, within a range not degrading the effects of the invention. As the conductive particles, for example, metal particles, conductive oxide particles such as tin-doped indium oxide (ITO) particles, antimony doped tin oxide (ATO) particles, cesium-doped tungsten oxide (CWO) particles are used. Particularly, ITO is preferable in order to increase infrared light reflection of the fibrous conductive particles-containing layer. From a viewpoint of the effect, a content of the fibrous conductive particles such as metal nanowires (preferably, metal nanowires having an aspect ratio equal to or greater than 10) is preferably equal to or greater than 50%, more preferably equal to or greater than 60%, and particularly preferably equal to or greater than 75%, based on volume, with respect to the total amount of the conductive material containing the fibrous conductive particles such as metal nanowires. When the content of the fibrous conductive particles such as metal nanowires is 50%, it is possible to easily obtain a fibrous conductive particles-containing layer having high heat insulating properties.

The conductive particles other than the fibrous conductive particles such as metal nanowires may not significantly contribute to conductivity of the fibrous conductive particles-containing layer and may have absorption in a visible light region. It is particularly preferable that the conductive particles are metal and do not have a shape with strong plasmon absorption such as a spherical shape, from a viewpoint of not deteriorating transparency of the fibrous conductive particles-containing layer.

Here, a percentage of the fibrous conductive particles such as metal nanowires can be acquired as follows. For example, in a case where the fibrous conductive particles are silver nanowires and the conductive particles are silver particles, a silver nanowires aqueous dispersion is filtered to separate silver nanowires and other conductive particles, each of an amount of silver remaining on the filter paper and an amount of silver transmitted through the filter paper are measured by using a inductively coupled plasma (ICP) emission analysis device, and the percentage of the metal nanowires can be calculated. The aspect ratio of the fibrous conductive particles such as metal nanowires is calculated by observing the fibrous conductive particles such as metal nanowires remaining on the filter paper using a TEM and measuring each of short axis lengths and long axis lengths of the fibrous conductive particles such as 300 metal nanowires.

The measurement method of the average long axis length and the average short axis length of the fibrous conductive particles such as metal nanowires are as described above.

(Film Thickness)

An average film thickness of the fibrous conductive particles-containing layer is normally selected from a range of 0.005 μm to 2 μm. For example, when the average film thickness thereof is 0.001 μm to 0.5 μm, sufficient durability and film hardness are obtained. Particularly, the average film thickness thereof is preferably in a range of 0.01 μm to 0.1 μm, because the allowable range in the manufacturing can be ensured.

It is preferable that, by providing a fibrous conductive particles-containing layer satisfying at least one of the condition (i) or (ii) described above, high heat insulating properties and transparency are maintained, fibrous conductive particles such as metal nanowires are stably solidified due to a sol-gel hardened material, and high strength and durability are realized. Even when the fibrous conductive particles-containing layer is a thin layer having a film thickness of 0.005 μm to 0.5 μm, for example, it is possible to obtain a fibrous conductive particles-containing layer having abrasion resistance, heat resistance, moisture-heat resistance, and bending resistance without practical problems. Accordingly, the heat insulating film of the embodiment of the invention is suitably used for various purposes. When it is necessary to provide a thin layer, a film thickness thereof may be 0.005 μm to 0.5 μm, preferably 0.007 μm to 0.3 more preferably 0.008 μm to 0.2 μm, and particularly preferably 0.01 μm to 0.1 μm. By setting the fibrous conductive particles-containing layer to be a thinner layer as described above, transparency of the fibrous conductive particles-containing layer is further improved.

Regarding an average film thickness of the fibrous conductive particles-containing layer, film thicknesses of five spots of the fibrous conductive particles-containing layer are measured by directly observing the cross section of the fibrous conductive particles-containing layer using an electron microscope, and an arithmetic average value thereof is calculated. In addition, the film thickness of the fibrous conductive particles-containing layer can also be measured as a level difference between a portion where the fibrous conductive particles-containing layer is formed and a portion where the fibrous conductive particles-containing layer is removed, by using a stylus type surface shape measurement device (Dektak (registered trademark) 150, manufactured by Bruker AXS K.K). However, some parts of the support may be removed when removing the fibrous conductive particles-containing layer and an error regarding the fibrous conductive particles-containing layer formed easily occurs, because the fibrous conductive particles-containing layer is a thin film. Therefore, in the following examples, the average film thickness measured by using an electron microscope is shown.

<Protective Layer>

The heat insulating film of the invention includes the support, the fibrous conductive particles-containing layer, and the protective layer, in this order, and the protective layer includes a material having an average transmittance for far infrared rays at a wavelength of 5 μm to 10 μm in conversion of a film thickness as 20 μm which is equal to or greater than 50% as a main component. The heat insulating film of the invention includes the protective layer (reference numeral 21 in FIG. 1) on the fibrous conductive particles-containing layer (reference numeral 20 in FIG. 1).

The protective layer includes the material having an average transmittance for far infrared rays at a wavelength of 5 μm to 10 μm in conversion of a film thickness as 20 μm which is equal to or greater than 50% as a main component (includes 50% by mass or more of the material). The content of the material having an average transmittance for far infrared rays at a wavelength of 5 μm to 10 μm in conversion of a film thickness as 20 μm which is equal to or greater than 50% is preferably equal to or greater than 70% by mass, from a viewpoint of increasing heat insulating properties, more preferably equal to or greater than 90% by mass, and particularly preferably 100% by mass.

A preferable range of the material having an average transmittance for far infrared rays at a wavelength of 5 μm to 10 μm in conversion of a film thickness as 20 μm which is equal to or greater than 50% used as the material of the protective layer is the same as the preferable range of the material having an average transmittance for far infrared rays at a wavelength of 5 μm to 10 μm in conversion of a film thickness as 20 μm which is equal to or greater than 50% used as the binder of the fibrous conductive particles-containing layer. Particularly, in the heat insulating film of the invention, the main component of the protective layer is preferably polycycloolefin or polyacrylonitrile.

It is preferable that the protective layer has low water-vapor permeability, from a viewpoint of improving heat insulating properties and moisture-heat resistance. As the water-vapor permeability of the protective layer, a value obtained by multiplying moisture-vapor transmission by a film thickness can be used as an index. In the invention, examples of the material having low moisture-vapor transmission which can be preferably used in the protective layer include polycycloolefin and polyacrylonitrile. The moisture-vapor transmission of the protective layer is, for example, preferably equal to or smaller than 10 g/m²·day, more preferably equal to or smaller than 5 g/m²·day, and particularly preferably equal to or smaller than 1 g/m²·day.

(Film Thickness)

In the heat insulating film of the invention, a film thickness of the protective layer is preferably 0.1 to 5 μm, from a viewpoint of heat insulating properties, more preferably greater than 0.5 μm and equal to or smaller than 5 μm, from a viewpoint of satisfying both heat insulating properties and scratch resistance, and particularly preferably 2 to 4 μm, from a viewpoint of further increasing heat insulating properties and moisture-heat resistance.

The protective layer may include oxide particles, in order to adjust a refractive index or increase surface hardness. Examples of oxide particles include silicon oxide, titanium oxide, and zirconium oxide. Since the protective layer is the outermost layer of the heat insulating film, silicon oxide having a low refractive index is preferably used from a viewpoint of prevention of reflection and silicon oxide of hollow particles is particularly preferable.

A particle diameter of the oxide particles is preferably in a range of 1 to 500 nm and more preferably in a range of 10 to 200 nm. The amount of the oxide particles added is preferably in a range of 1% to 50% by mass and more preferably in a range of 10% to 40% by mass.

<Interlayer>

It is preferable that the heat insulating film includes at least one interlayer between the support and the fibrous conductive particles-containing layer. When the interlayer is provided between the support and the fibrous conductive particles-containing layer, at least one of adhesiveness between the support and the fibrous conductive particles-containing layer, visible light transmittance of the fibrous conductive particles-containing layer, the haze of the fibrous conductive particles-containing layer, or film hardness of the fibrous conductive particles-containing layer can be improved.

As the interlayer, an adhesive layer for improving adhesiveness between the support and the fibrous conductive particles-containing layer or a functional layer for improving functionality with interaction with a component contained in the fibrous conductive particles-containing layer is used, and the interlayer is suitably selected according to the purpose.

A configuration of the heat insulating film further including the interlayer will be described with reference to the drawing.

In FIG. 3, the fibrous conductive particles-containing layer 20 is provided on the adhesive layer-attached support 101 which is formed by providing the interlayer (first adhesive layer 31 and second adhesive layer 32) on the support. The interlayer including the first adhesive layer 31 having excellent affinity with the support 10 and the second adhesive layer 32 having excellent affinity with fibrous conductive particles-containing layer 20 is provided between the support 10 and the fibrous conductive particles-containing layer 20.

An interlayer having a configuration other than that of FIG. 3 may be provided, and for example, it is also preferable that an interlayer including a functional layer adjacent to the fibrous conductive particles-containing layer 20 is provided between the support 10 and the fibrous conductive particles-containing layer 20, in addition to the first adhesive layer 31 and the second adhesive layer 32 which are the same as those in the third embodiment (not shown).

<Near Infrared Shielding Material>

By using a near infrared shielding material, it is possible to increase shielding properties for near infrared rays.

Examples of the near infrared shielding material include plate-shaped metal particles (for example, silver nanodisks), an organic multilayer film, and spherical metal oxide particles (for example, tin-doped indium oxide (ITO) particles, antimony-doped tin oxide (ATO) particles, and cesium-doped tungsten oxide (CWO) particles).

A near infrared shielding layer is preferably formed by using the near infrared shielding materials alone.

(Near Infrared Shielding Layer Using Plate-Shaped Metal Particles)

From a viewpoint of heat ray shielding properties (solar heat gain coefficient), a heat ray reflection type which does not cause re-radiation is desirable, compared to a heat ray absorption type in which re-radiation of absorbed light into a room (approximately ⅓ amount of solar radiation energy absorbed) is performed. From a viewpoint of reflection of near infrared ray, plate-shaped metal particles are preferably used as the near infrared shielding material. In the near infrared shielding layer using the plate-shaped metal particles, near infrared shielding materials disclosed in paragraphs “0019” to “0046” of JP2013-228694A, JP2013-083974A, JP2013-080222A, JP2013-080221A, JP2013-077007A, and JP2013-068945A can be used and the description in these documents is incorporated in this specification.

Specifically, the near infrared shielding layer is a layer containing at least one kind of metal particles, and the metal particles preferably contain 60% by number or more of plate-shaped metal particles having a hexagonal or circular shape, and the principal plane of the plate-shaped metal particles having a hexagonal or circular shape is preferably plane-oriented in a range of averagely 0° to ±30° with respect to one surface of the near infrared shielding layer.

A material of the metal particles is not particularly limited and can be suitably selected according to the purpose. Preferable examples thereof include silver, gold, aluminum, copper, rhodium, nickel, and platinum, from a viewpoint of high reflectivity of heat rays (near infrared rays).

(Organic Multilayer Film and Spherical Metal Oxide Particles)

As the near infrared shielding layer using an organic multilayer film, a layer disclosed in paragraphs “0039” to “0044” of JP2012-256041A can be preferably used and the description in this document is incorporated in this specification.

As the near infrared shielding layer using spherical metal oxide particles, layers disclosed in paragraphs “0038” and “0039” of JP2013-37013A can be preferably used and the description in this document is incorporated in this specification.

<Pressure Sensitive Adhesive Layer>

The heat insulating film of the invention preferably includes a pressure sensitive adhesive layer. The pressure sensitive adhesive layer can contain an ultraviolet absorbing agent.

A material capable of being used for forming the pressure sensitive adhesive layer is not particularly limited and can be suitably selected according to the purpose. Examples thereof include a polyvinyl butyral resin, an acrylic resin, a styrene/acrylic resin, a urethane resin, a polyester resin, and silicone resin. These may be used alone or in combination of two or more kinds thereof. The pressure sensitive adhesive layer formed of these materials can be formed by coating.

In addition, an antistatic agent, a lubricant, or an antiblocking agent may be added to the pressure sensitive adhesive layer.

A thickness of the pressure sensitive adhesive layer is preferably 0.1 μm to 10 μm.

[Manufacturing Method of Heat Insulating Film]

A method for manufacturing the heat insulating film of the invention is not particularly limited, and a first aspect and a second aspect of the manufacturing method of the heat insulating film of the invention which will be described below are preferable.

According to the first aspect, there is provided a manufacturing method of a heat insulating film of the invention including: a step of applying a coating solution for forming a fibrous conductive particles-containing layer including a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component, and fibrous conductive particles, on a support to form a fibrous conductive particles-containing layer; and a step of applying a coating solution for forming a protective layer including a material having an average transmittance for far infrared rays at a wavelength of 5 μm to 10 μm in conversion of a film thickness as 20 μm which is equal to or greater than 50%, as a main component, on the fibrous conductive particles-containing layer to form a protective layer.

According to the second aspect, there is provided a manufacturing method of a heat insulating film of the invention including: a step of applying a coating solution for forming a precursor layer including fibrous conductive particles on a support to form a precursor layer; a step of applying a coating solution for converting a precursor layer including a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component, on the precursor layer and causing the coating solution to permeate the precursor layer to form a fibrous conductive particles-containing layer; and a step of applying a coating solution for forming a protective layer including a material having an average transmittance for far infrared rays at a wavelength of 5 μm to 10 μm in conversion of a film thickness as 20 μm which is equal to or greater than 50%, as a main component, on the fibrous conductive particles-containing layer to form a protective layer.

—First Aspect—

As a method of forming a fibrous conductive particles-containing layer on a support in the first aspect of the manufacturing method of the heat insulating film of the invention, a general coating method can be performed, in a case where a binder including a material other than metal oxides derived from the specific alkoxide compound described above (for example, conductive polymer described above) as a main component as the material having a maximum peak value of reflectivity for far infrared rays at a wavelength of 5 to 25 μm which is equal to or greater than 20%, or a binder including the material having an average transmittance for far infrared rays at a wavelength of 5 μm to 10 μm in conversion of a film thickness as 20 μm which is equal to or greater than 50% as a main component, is used in the coating solution for forming a fibrous conductive particles-containing layer.

In one embodiment, the coating solution for forming a fibrous conductive particles-containing layer may be prepared by preparing an aqueous dispersion of fibrous conductive particles such as metal nanowires, and mixing this dispersion with a binder including a material other than metal oxides derived from the specific alkoxide compound described above (for example, conductive polymer described above) as a main component as the material having a maximum peak value of reflectivity for far infrared rays at a wavelength of 5 to 25 μm which is equal to or greater than 20%, or a binder including the material having an average transmittance for far infrared rays at a wavelength of 5 μm to 10 μm in conversion of a film thickness as 20 μm which is equal to or greater than 50% as a main component.

Meanwhile, as a method of forming a fibrous conductive particles-containing layer on a support in the first aspect of the manufacturing method of the heat insulating film of the invention, a fibrous conductive particles-containing layer can be manufactured by a method at least including: forming a liquid film by applying a coating solution for forming a fibrous conductive particles-containing layer (hereinafter, also referred to as a “sol-gel coating solution”) on a support; and forming a fibrous conductive particles-containing layer by allowing a reaction such as hydrolysis and polycondensation of the specified alkoxide compound in the liquid film (hereinafter, this reaction such as hydrolysis and polycondensation is also referred to as a “sol-gel reaction”), in a case of using a binder including metal oxides derived from the specific alkoxide compound as a main component as the material having a maximum peak value of reflectivity for far infrared rays at a wavelength of 5 to 25 μm which is equal to or greater than 20%, for example. This method may or may not further include evaporating (drying) performed by heating water included in the coating solution for forming a fibrous conductive particles-containing layer as a solvent, if necessary.

In one embodiment, a sol-gel coating solution may be prepared by preparing an aqueous dispersion of the fibrous conductive particles such as metal nanowires and mixing this dispersion with the specified alkoxide compound. In one embodiment, a sol-gel coating solution may be prepared by preparing an aqueous solution containing the specified alkoxide compound, heating this aqueous solution to allow hydrolysis and polycondensation of at least some parts of the specified alkoxide compound to set a sol state, and mixing the aqueous solution in the sol state and the aqueous dispersion of the fibrous conductive particles such as metal nanowires with each other.

In order to promote a sol-gel reaction, it is practically preferable to use an acid catalyst or a basic catalyst together, in order to improve reaction efficiency.

After the coating, the drying can be performed using an arbitrary method, and it is preferable to perform the drying by heating.

In a case of using a binder including metal oxides derived from the specific alkoxide compound as a main component as the material having a maximum peak value of reflectivity for far infrared rays at a wavelength of 5 to 25 μm which is equal to or greater than 20%, a reaction such as hydrolysis and polycondensation of the specified alkoxide compound occurs in the coating film of the sol-gel coating solution formed on the support, and in order to promote the reaction, it is preferable that the coating film is heated and dried. A heating temperature for promoting the sol-gel reaction is suitably in a range of 30° C. to 200° C. and more preferably in a range of 50° C. to 180° C.

The heating and drying time is preferably 10 seconds to 300 minutes and more preferably 1 minute to 120 minutes.

—Second Aspect—

In the second aspect, the manufacturing method of the heat insulating film of the invention includes a step of applying a coating solution for forming a precursor layer including fibrous conductive particles on a support to form a precursor layer. In this case, the coating solution for forming a precursor layer may include or may not include a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component, but it is preferable not to include the binder.

As the coating solution for a precursor layer including fibrous conductive particles, an aqueous dispersed material of fibrous conductive particles obtained in the manufacturing method of the fibrous conductive particles can be used as it is. The preferred aspect of the coating solution for a precursor layer including fibrous conductive particles is the same as the preferred aspect of the aqueous dispersed material of fibrous conductive particles subjected to desalinization treatment obtained by the manufacturing method of the fibrous conductive particles.

The formed precursor layer can be dried by an arbitrary method and is preferably dried by heating.

In the second aspect, the manufacturing method of the heat insulating film of the invention includes a step of applying a coating solution for converting a precursor layer including a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component, on the precursor layer and causing the coating solution to permeate the precursor layer to form a fibrous conductive particles-containing layer. A method of causing the coating solution for converting a precursor layer to permeate the precursor layer is not particularly limited, and it is preferable to cause the penetration without using a particularly special step, after applying the coating solution for converting a precursor layer on the precursor layer. In the second aspect, it is possible to minutely control the amount of the binder of the fibrous conductive particles-containing layer and to easily form binder distribution in a thickness direction of the fibrous conductive particles-containing layer.

—Coating Method—

In the forming method of the fibrous conductive particles-containing layer, the coating method of each step described above is not particularly limited. General coating methods can be used and any method can be suitably selected according to the purpose. Examples thereof include a roll coating method, a bar coating method, a dip coating method, a spin coating method, a casting method, a die coating method, a blade coating method, a gravure coating method, a curtain coating method, a spray coating method, and doctor coating method.

(Formation of Protective Layer)

The manufacturing method of the heat insulating film of the invention includes a step of applying a coating solution for forming a protective layer including a material having an average transmittance for far infrared rays at a wavelength of 5 μm to 10 μm in conversion of a film thickness as 20 μm which is equal to or greater than 50%, as a main component, on the fibrous conductive particles-containing layer to form a protective layer.

For the coating solution for forming a protective layer, the same solvent as that used for the fibrous conductive particles-containing layer is used, and accordingly, it is possible to form a uniform liquid film on the fibrous conductive particles-containing layer.

The method of applying the coating solution on the fibrous conductive particles-containing layer to form a protective layer is not particularly limited, and the same coating method used for the fibrous conductive particles-containing layer can be performed.

[Heat Insulating Glass and Window]

The heat insulating glass of the invention is a heat insulating glass obtained by laminating the heat insulating film of the invention and a glass.

The window of the invention is a window including a transparent window support and the heat insulating film of the invention bonded to the transparent window support.

As the transparent window support, a transparent window support having a thickness equal to or greater than 0.5 mm is preferable, a transparent window support having a thickness equal to or greater than 1 mm is more preferable, and from a viewpoint of preventing thermal conduction due to the thickness of the transparent window support and increasing warmth, a transparent window support having a thickness equal to or greater than 2 mm is particularly preferable.

In general, a plate-shaped or a sheet-shaped material is used as the transparent window support.

Examples of the transparent window support include transparent glass such as white plate glass, blue plate glass, or silica-coated blue plate glass; and a synthetic resin such as polycarbonate, polyether sulfone, polyester, an acrylic resin, a vinyl chloride resin, an aromatic polyamide resin, polyamide imide, or polyimide. Among these, he transparent window support is preferably glass or a resin plate and more preferably glass.

Components configuring glass or window glass are not particularly limited, and transparent glass such as white plate glass, blue plate glass, or silica-coated blue plate glass can be used as the glass or the window glass, for example.

The glass used in the invention preferably has a smooth surface and is preferably float glass.

When acquiring visible light transmittance of the heat insulating glass of the invention, it is preferable to perform the measurement by bonding the heat insulating film of the invention to a blue plate glass having a thickness of 3 mm. As the blue plate glass having a thickness of 3 mm, a glass disclosed in JIS A 5759 is preferably used.

The heat insulating film of the invention is bonded to the inner side of the window, that is, the indoor side of the window glass.

In the heat insulating glass of the invention or the window of the invention, the fibrous conductive particles-containing layer of the heat insulating film of the invention is disposed on the surface of the support on a side opposite to the surface of the window (glass or transparent window support) side. In the invention, although the heat insulating properties are dependent on the thickness of the fibrous conductive particles-containing layer, a distance between the fibrous conductive particles-containing layer and the outermost surface on the indoor side is preferably within 7 μm, from a viewpoint of increasing heat insulating properties, more preferably within 5 μm, particularly preferably in a range of 0.1 to 5 μm, and more particularly preferably in a range of 2 to 4 μm.

The fibrous conductive particles-containing layer of the heat insulating film of the invention is preferably the second outermost layer on the indoor side, from a viewpoint of increasing heat insulating properties.

In the heat insulating glass of the invention or the window of the invention, it is preferable that the near infrared shielding layer is installed on a sunlight side as possible, because infrared rays to be incident to the room can be reflected in advance, and from this viewpoint, the pressure sensitive adhesive layer is preferably laminated so that the near infrared shielding layer is installed on a sunlight incident side. Specifically, it is preferable that the pressure sensitive adhesive layer is provided on the near infrared shielding layer or on the functional layer such as an overcoat layer provided on the near infrared shielding layer and the near infrared shielding layer is bonded to the window glass through this pressure sensitive adhesive layer.

When bonding the heat insulating film of the invention to the window glass, the heat insulating film of the invention in which the pressure sensitive adhesive layer is provided by coating or laminating is prepared, an aqueous solution containing a surfactant (mainly anionic) is sprayed to the surface of the window glass or the surface of the pressure sensitive adhesive layer of the heat insulating film of the invention in advance, and the heat insulating film of the invention may be installed on the window glass through the pressure sensitive adhesive layer. The pressure sensitive adhesiveness of the pressure sensitive adhesive layer decreases while moisture is evaporated, and accordingly, the position of the heat insulating film of the invention can be adjusted on the glass surface. After determining the bonding position of the heat insulating film of the invention to the window glass, the moisture remaining between the window glass and the heat insulating film of the invention is swept out from the center to the edge of the glass by using a squeegee or the like, and accordingly, the heat insulating film of the invention can be fixed to the surface of the window glass. By doing so, the heat insulating film of the invention can be installed on the window glass.

<Building Material, Building, and Vehicles>

The usage of the heat insulating film, the heat insulating glass, and the window of the invention is not particularly limited and can be suitably selected according to the purposes. For example, the heat insulating film, the heat insulating glass, and the window are used for vehicles, for building materials or buildings, and for agriculture. Among these, the heat insulating film, the heat insulating glass, and the window are preferably used in building materials, buildings, and vehicles, from a viewpoint of energy saving effects.

The building material is a building material including the heat insulating film of the invention or the heat insulating glass of the invention.

The building is a building including the heat insulating film of the invention, the heat insulating glass of the invention, the building material of the invention, or the window of the invention. Examples of the building include a house, an office building, and a warehouse.

The vehicle is a vehicle including the heat insulating film of the invention, the heat insulating glass of the invention, or the window of the invention. Examples of the vehicle include a car, a railway vehicle, and a ship.

### EXAMPLES

Hereinafter, the invention will be described more specifically with reference to the examples and comparative examples. The materials, the usage amount, the ratio, the process content, and the process procedure shown in the following examples can be suitably changed within a range not departing from the gist of the invention. Therefore, the ranges of the invention is not narrowly interpreted based on the specific examples shown below.

### Preparation Example 1

<Preparation of Silver Nanowire Aqueous Dispersion (1)>

The following liquid additives A, G, and H were prepared in advance.

(Liquid Additive A)

5.1 g of silver nitrate powder was dissolved in 500 mL of pure water. After that, 1 mol/L of ammonia water was added thereto until a transparent material was obtained. Pure water was added so that the total amount of the mixture becomes 1,000 mL.

(Liquid Additive G)

1 g of glucose powder was dissolved in 280 mL of pure water to prepare a liquid additive G

(Liquid Additive H)

4 g of hexadecyl-trimethylammoniumbromide (HTAB) powder was dissolved in 220 mL of pure water to prepare a liquid additive H.

Next, a silver nanowire aqueous dispersion (1) was prepared as follows.

410 mL of pure water was put in a three-necked flask, and 82.5 mL of the liquid additive H and 206 mL of the liquid additive G were added through a funnel while stirring the solution at 20° C. (first stage). 206 mL of the liquid additive A was added to this solution at a flow rate of 2.0 mL/min and a stirring rotation rate of 800 round per minute (rpm) (second stage). After 10 minutes, 82.5 mL of the liquid additive H was added (third stage). Then, the internal temperature was increased to 73° C. at a rate of 3° C./min. After that, the stirring rotation rate was decreased to 200 rpm and the solution was heated for 5.5 hours. The obtained aqueous dispersion was cooled.

An ultrafiltration module SIP 1013 (product name, manufactured by Asahi Kasei Corporation, molecular weight cutoff: 6,000), a magnet pump, and a stainless steel cup were connected to each other through silicone tubes to prepare an ultrafiltration device.

The cooled aqueous dispersion described above was put into the stainless steel cup of the ultrafiltration device and the pump was operated to perform ultrafiltration. 950 mL of distilled water was added into the stainless steel cup and washing was performed, when the amount of a filtrate from the ultrafiltration module has become 50 mL. The washing described above was repeatedly performed until electric conductivity (measured by CM-25R manufactured by DKK-TOA Corporation) has become equal to or smaller than 50 μS/cm, and then, the concentration was performed to obtain 0.84% silver nanowire aqueous dispersion (1). The obtained silver nanowire aqueous dispersion (1) was set as a silver nanowire aqueous dispersion of Preparation Example 1. An average short axis length and an average long axis length of silver nanowires which are fibrous conductive particles contained in the silver nanowire aqueous dispersion of Preparation Example 1 obtained and a coefficient of variation of short axis lengths of the fibrous conductive particles were measured as described above. As a result, it was found that the silver nanowires having an average short axis length of 17.2 nm, an average long axis length of 34.2 μm, and a coefficient of variation of 17.8% were obtained. Hereinafter, the “silver nanowire aqueous dispersion (1)” indicates the silver nanowire aqueous dispersion obtained by the method described above.

### Preparation Example 2

<Preparation of Adhesive Layer-Attached Support (PET Substrate; Reference Numeral 101 in FIG. 3)>

A solution for adhesion 1 was prepared with the following combination.

(Solution for Adhesion 1)
TAKELAC (registered trademark) WS-4000: 5.0 parts by mass
(polyurethane for coating, solid content concentration of 30%, manufactured by Mitsui Chemicals)
Surfactant: 0.3 parts by mass
(product name: NAROACTY HN-100 manufactured by Sanyo Chemical Industries)
Surfactant: 0.3 parts by mass
(SANDET (registered trademark) BL, solid content concentration of 43%, manufactured by Sanyo Chemical Industries)
Water: 94.4 parts by mass

Corona discharge treatment was performed with respect to one surface of a PET film (reference numeral 10 in FIG. 3) having a thickness of 75 μm used as a support, and the solution for adhesion 1 was applied to the surface subjected to the corona discharge treatment and dried at 120° C. for 2 minutes to form a first adhesive layer having a thickness of 0.11 μm (reference numeral 31 of FIG. 3).

A solution for adhesion 2 was prepared with the following combination.

(Solution for Adhesion 2)
Tetraethoxysilane: 5.0 parts by mass

(product name: KBE-04 manufactured by Shin-Etsu Chemical Co., Ltd.)
3-glycidoxypropyltrimethoxysilane: 3.2 parts by mass

(product name: KBM-403 manufactured by Shin-Etsu Chemical Co., Ltd.)
2-(3,4-epoxycyclohexyl) ethyl trimethoxysilane: 1.8 parts by mass

(product name: KBM-303 manufactured by Shin-Etsu Chemical Co., Ltd.)
Acetic acid aqueous solution (acetic acid concentration=0.05%, power of Hydrogen (pH)=5.2): 10.0 parts by mass
Hardener: 0.8 parts by mass

(boric acid manufactured by Wako Pure Chemical Industries, Ltd.)
Colloidal silica: 60.0 parts by mass

(SNOWTEX (registered trademark) O, average particle diameter of 10 nm to 20 nm, solid content concentration of 20%, pH=2.6, manufactured by Nissan Chemical Industries, Ltd.)
Surfactant: 0.2 parts by mass

(product name: NAROACTY HN-100 manufactured by Sanyo Chemical Industries)
Surfactant: 0.2 parts by mass

(SANDET (registered trademark) BL, solid content concentration of 43%, manufactured by Sanyo Chemical Industries)

The solution for adhesion 2 was prepared by the following method. While vigorously stirring the acetic acid aqueous solution, 3-glycidoxypropyltrimethoxysilane was added dropwise into this acetic acid aqueous solution for 3 minutes. Next, 2-(3,4-epoxycyclohexyl) ethyl trimethoxysilane was added for 3 minutes while strongly stirring the acetic acid aqueous solution. Then, tetraethoxysilane was added for 5 minutes while strongly stirring the acetic acid aqueous solution, and stirring was continued for 2 hours. Next, colloidal silica, the hardener, and the surfactant were sequentially added to prepare the solution for adhesion 2.

The surface of the first adhesive layer (reference numeral 31 in FIG. 3) described above was subjected to corona discharge treatment, the solution for adhesion 2 described above was applied to this surface by a barcode method and heated and dried at 170° C. for 1 minute, and a second adhesive layer (reference numeral 32 in FIG. 3) having a thickness of 0.5 μm was formed to obtain an adhesive layer-attached support (PET substrate; reference numeral 101 in FIG. 3).

[Measurement Method]

<Measurement of Far Infrared Reflectivity•Far Infrared Transmittance of Material Used and Calculation of Average Transmittance in Conversion of Film Thickness>

Each binder material was formed on a 2 cm×2 cm silicon single crystal (thickness of 2 mm) so that a film thickness becomes 0.1 μm, and a sample for reflection spectra measurement was obtained.

Each binder material and each protective layer material were applied on a release film so that a film thickness becomes 5 to 50 μm, and dried to obtain a self supporting film. After the drying, the self supporting film peeled off from the release film was cut to have a size of 2 cm×2 cm to obtain a sample for transmission spectra measurement.

The reflection spectra of the sample for reflection spectra measurement at a wavelength in a range of 5 μm to 25 μm and transmission spectra of the sample for transmission spectrum measurement were measured by using an infrared spectroscope (IFS 66 v/S manufactured by Bruker Optics K.K.).

A maximum peak value of reflectivity was acquired from reflection spectra of the sample for reflection spectrum measurement at a wavelength in a range of 5 μm to 25 μm to set as a maximum peak value of reflectivity of the binder material used for far infrared rays at a wavelength of 5 to 25 μm.

Regarding an average transmittance in conversion of film thickness, transmission spectra at a wavelength in a range of 5 μm to 10 μm were measured, a film thickness of the binder material or protective layer material used was measured, and the conversion of transmittance at each wavelength was performed by using the following Expression (1) to obtain spectra of transmittance at each wavelength subjected to film thickness conversion. In addition, an arithmetic mean value of the transmittance at each wavelength subjected to film thickness conversion of spectra obtained was obtained to set as an average transmittance of the binder material or protective layer material used for far infrared rays at a wavelength of 5 μm to 10 μm in conversion of a film thickness as 20 μm.

T′=T^{(x/20)} Expression (1)

(here, T′ represents transmittance at each wavelength subjected to film thickness conversion, T represents transmittance at each wavelength, and x represents an average film thickness (μm) of a sample for measurement.)

### Example 1

<Formation of Fibrous Conductive Particles-Containing Layer by Coating>

A solution of an alkoxide compound having the following composition was stirred at 60° C. for 1 hour and a uniform state was confirmed. The prepared solution was set as a sol-gel solution.

(Solution of Alkoxide Compound)
Tetraethoxysilane: 5.0 parts by mass

(product name: KBE-04 manufactured by Shin-Etsu Chemical Co., Ltd.)
1% Acetic acid aqueous solution: 10.0 parts by mass
Distilled water: 4.0 parts by mass

Using the obtained sol-gel solution, a sample for reflection spectra measurement used in the measurement method described above was prepared (after forming a film, drying was performed at 175° C. for 1 minute to allow a sol-gel reaction). A maximum peak value of reflectivity of the binder material for far infrared rays at a wavelength of 5 to 25 μm was 27%. The obtained result was disclosed in the following Table 1 as “far infrared reflectivity”. Since tetraethoxysilane in the sol-gel solution is present in the film as SiO₂ after the sol-gel reaction, this was disclosed in a column of the binder material of the fibrous conductive particles-containing layer in the following Table 1 as “SiO₂”.

2.09 parts by mass of the obtained sol-gel solution and 32.70 parts by mass of the silver nanowire aqueous dispersion (1) obtained in Preparation Example 1 were mixed with each other and diluted using the distilled water to obtain a sol-gel coating solution which is the coating solution for forming a fibrous conductive particles-containing layer.

Corona discharge treatment was performed with respect to the surface of the second adhesive layer of the adhesive layer-attached support, and the sol-gel coating solution was applied to the surface thereof so that the silver amount is 0.040 g/m² and the total solid content coating amount is 0.120 g/m² by using a barcode method. After that, the sol-gel coating solution was dried at 175° C. for 1 minute to allow a sol-gel reaction and a fibrous conductive particles-containing layer was formed. A mass ratio of tetraethoxysilane (alkoxide compound)/silver nanowires of the fibrous conductive particles-containing layer was 2/1.

<Formation of Protective Layer by Coating>

A cycloolefin polymer (COP) solution of the following composition was prepared and the obtained COP solution was set as a coating solution for forming a protective layer.
Cycloolefin polymer: 1.0 part by mass (product name: ZEONEX 480R manufactured by Zeon Corporation)
1-isopropyl-4-methyl cyclohexane: 15.0 parts by mass

The sample for transmission spectra measurement used in the measurement method was prepared using the obtained COP solution, and an average transmittance for far infrared rays at a wavelength of 5 μm to 10 μm in conversion of a film thickness as 20 μm was 86%. The result obtained was disclosed in the following Table 1 as a “far infrared transmittance”.

The COP solution was applied on the surface of the fibrous conductive particles-containing layer using an applicator, and heated at 170° C. for 1 minute to be dried, a protective layer having a thickness of 1 μm was formed, and a heat insulating film of Example 1 was obtained.

### Example 2

A heat insulating film of Example 2 was obtained in the same manner as in Example 1, except for performing the application by adjusting an applicator so that a thickness of a protective layer becomes 3 μm.

### Example 3

A heat insulating film of Example 3 was obtained in the same manner as in Example 1, except for performing the application by adjusting an applicator so that a thickness of a protective layer becomes 7 μm.

### Example 4

An acrylonitrile polymer (PAN) solution having the following composition was prepared and the obtained PAN solution was set as a coating solution for forming a protective layer.
Completely hydrogenated nitrile rubber: 1.0 part by mass (product name: THERBAN 5005 manufactured by LANXESS)
Methyl ethyl ketone: 15.0 parts by mass

The sample for transmission spectra measurement used in the measurement method was prepared using the obtained PAN solution, and an average transmittance for far infrared rays at a wavelength of 5 μm to 10 μm in conversion of a film thickness as 20 μm was 62%. The result obtained was disclosed in the following Table 1 as a “far infrared transmittance”.

A protective layer was formed using the following method, instead of forming a protective layer using the COP solution as in Example 1. Specifically, the PAN solution was applied on the surface of the fibrous conductive particles-containing layer using an applicator, and heated at 120° C. for 1 minute to be dried, and a protective layer having a thickness of 1 μm was formed. After that, the surface side of the protective layer was irradiated with electron beams (acceleration voltage of 150 kV, cumulative exposure dose of 400 kGy) by using an electron beam irradiation apparatus (EC250/15/180L manufactured by Eye Electron Beam Co., Ltd.) and a heat insulating film of Example 4 was obtained.

### Example 5

Poly(3,4-ethylenedioxythiophene) (PEDOT) solution doped with polystyrene sulfonate having the following composition was prepared.
Poly(3,4-ethylenedioxythiophene) aqueous dispersion: 50.0 parts by mass (Clevios P AI 4083 manufactured by Heraeus)
Distilled water: 2.0 parts by mass
Ethanol: 8.0 parts by mass

Using the obtained PEDOT solution, a sample for reflection spectra measurement used in the measurement method described above was prepared, and a maximum peak value of reflectivity of the binder material for far infrared rays at a wavelength of 5 to 25 μm was 24%. The obtained result was disclosed in the following Table 1 as “far infrared reflectivity”.

18.0 parts by mass of the obtained PEDOT solution and 32.70 parts by mass of the silver nanowire aqueous dispersion (1) obtained in Preparation Example 1 were mixed with each other and diluted using the distilled water to obtain a silver nanowires-dispersed PEDOT coating solution which is the coating solution for forming a fibrous conductive particles-containing layer.

Corona discharge treatment was performed with respect to the surface of the second adhesive layer of the adhesive layer-attached support, and the silver nanowires-dispersed PEDOT coating solution was applied to the surface thereof so that the silver amount is 0.040 g/m² and the total solid content coating amount is 0.120 g/m² by using a barcode method. After that, the silver nanowires-dispersed PEDOT coating solution was dried at 100° C. for 2 minutes and a fibrous conductive particles-containing layer was formed. A mass ratio of PEDOT/silver nanowires of the fibrous conductive particles-containing layer was 2/1.

A protective layer having a thickness of 1 μm was formed on the surface of the fibrous conductive particles-containing layer in the same manner as in Example 1, and a heat insulating film of Example 5 was obtained.

### Example 6

The silver nanowire aqueous dispersion obtained in Preparation Example 1 was subjected to solvent substitution into n-propanol and then subjected to solvent substitution into 1-isopropyl-4-methyl cyclohexane, without changing the concentration of the silver nanowires of the coating solution.

3.50 parts by mass of the COP solution used for application of the protective layer in Example 1 and 32.70 parts by mass of the silver nanowire aqueous dispersion subjected to the solvent substitution were mixed with each other and a silver nanowire-dispersed COP coating solution was obtained.

Corona discharge treatment was performed with respect to the surface of the second adhesive layer of the adhesive layer-attached support, and the silver nanowire-dispersed COP coating solution was applied to the surface thereof so that the silver amount is 0.040 g/m² and the total solid content coating amount is 0.120 g/m² by using a barcode method. After that, the silver nanowire-dispersed COP coating solution was dried at 100° C. for 2 minutes and a fibrous conductive particles-containing layer was formed. A mass ratio of COP/silver nanowires of the fibrous conductive particles-containing layer was 2/1.

A protective layer having a thickness of 1 μm was formed on the surface of the fibrous conductive particles-containing layer in the same manner as in Example 1, and a heat insulating film of Example 6 was obtained.

### Example 7

Corona discharge treatment was performed with respect to the surface of the second adhesive layer of the adhesive layer-attached support, and the silver nanowire aqueous dispersion (1) obtained in Preparation Example 1 was applied to the surface thereof so that the silver amount is 0.040 g/m² by using a barcode method, the silver nanowire aqueous dispersion was dried at 100° C. for 1 minute, and a silver nanowire layer which is a precursor layer was formed. The silver nanowire aqueous dispersion (1) was used as the coating solution for forming a precursor layer, in this embodiment.

After that, the solution of alkoxide compound prepared in Example 1 was diluted using the distilled water to obtain a sol-gel coating solution. By using the sol-gel coating solution as the coating solution for forming a precursor layer, the sol-gel coating solution was applied on the surface of the silver nanowire layer while penetrating the silver nanowire layer so as to fill gaps between silver nanowires, so that the total solid content coating amount is 0.080 g/m², the sol-gel coating solution was dried at 175° C. for 1 minute to allow a sol-gel reaction, and a fibrous conductive particles-containing layer in which silver nanowires are dispersed in a binder was formed.

A protective layer having a thickness of 1 μm was formed on the surface of the fibrous conductive particles-containing layer in the same manner as in Example 1, and a heat insulating film of Example 7 was obtained.

### Comparative Example 1

A heat insulating film of Comparative Example 1 was obtained in the same manner as in Example 1, except for not forming a protective layer.

### Comparative Example 2

A polymethylmethacrylate (PMMA) solution having the following composition was prepared.
PMMA resin: 1.0 part by mass (product name: DIANAL BR88 manufactured by Mitsubishi Rayon Co., Ltd.)
Methyl ethyl ketone: 15.0 parts by mass

The sample for transmission spectra measurement used in the measurement method was prepared using the obtained PMMA solution, and an average transmittance for far infrared rays at a wavelength of 5 μm to 10 μm in conversion of a film thickness as 20 μm was 42%. The result obtained was disclosed in the following Table 1 as a “far infrared transmittance”.

A heat insulating film of Comparative Example 2 was obtained in the same manner as in Example 1, except for changing the coating solution for a protective layer from the COP solution to the PMMA solution.

### Comparative Example 3

A polyurethane (PU) solution having the following composition was prepared.
Polyurethane aqueous dispersion: 5.0 parts by mass (product name: TAKELAC (registered trademark) WS-4000, manufactured by Mitsui Chemicals, Inc.)
Distilled water: 95.0 parts by mass

The sample for transmission spectra measurement used in the measurement method was prepared using the obtained PU solution and an average transmittance for far infrared rays at a wavelength of 5 μm to 10 μm in conversion of a film thickness as 20 μm was 24%. The result obtained was disclosed in the following Table 1 as a “far infrared transmittance”.

15.0 parts by mass of the obtained PU solution and 32.70 parts by mass of the silver nanowire aqueous dispersion (1) obtained in Preparation Example 1 were mixed with each other and diluted using the distilled water to obtain a silver nanowires-dispersed PU coating solution.

Corona discharge treatment was performed with respect to the surface of the second adhesive layer of the adhesive layer-attached support, and the silver nanowires-dispersed PU coating solution was applied to the surface thereof so that the silver amount is 0.040 g/m² and the total solid content coating amount is 0.120 g/m² by using a barcode method. After that, the silver nanowires-dispersed PU coating solution was dried at 120° C. for 2 minutes and a fibrous conductive particles-containing layer was formed. A mass ratio of PU/silver nanowires of the fibrous conductive particles-containing layer was 2/1.

A heat insulating film of Comparative Example 3 was obtained by forming a protective layer having a thickness of 1 μm on the surface of the fibrous conductive particles-containing layer in the same manner as in Example 1.

[Preparation of Heat Insulating Glass]

<Formation of Pressure Sensitive Adhesive Layer>

A pressure sensitive adhesive material was bonded onto a surface of a support opposing the fibrous conductive particles-containing layer of the heat insulating film prepared in each example and each comparative example, to form a pressure sensitive adhesive layer. PANACLEAN PD-S1 (pressure sensitive adhesive layer thickness of 25 μm) manufactured by PANAC Corporation, was used as the pressure sensitive adhesive material, and a peelable separator (silicone coat PET) of the pressure sensitive adhesive material was peeled off and was bonded to the surface of the support.

<Preparation of Heat Insulating Glass>

The other peelable separator (silicone coat PET) of the pressure sensitive adhesive material PD-S1 was peeled off from the pressure sensitive adhesive layer formed by the method described above, the pressure sensitive adhesive layer was bonded to a plate glass (thickness of plate glass: blue plate glass having a thickness of 3 mm) which is soda-lime silicate by using a 0.5% by mass diluent of REAL PERFECT (manufactured by Lintec Corporation) which is film processing liquid, and a heat insulating glass of each example and each comparative example was prepared.

Various evaluations which will be described later were performed using the heat insulating glasses of the examples and the comparative examples obtained as described above.

[Evaluation]

(1) Haze

The haze of the heat insulating glasses of the examples and the comparative examples was measured based on JIS-K-7105 by using a haze meter (NDH-2000 manufactured by Nippon Denshoku Industries Co., Ltd.) and the ranking was performed based on the following evaluation standard.

<<Evaluation Standard>>

A: a haze value is smaller than 2%

B: a haze value is equal to or greater than 2% and smaller than 3%

C: a haze value is equal to or greater than 3%

The results obtained are shown in the following Table 1 as “haze”.

(2) Heat Insulating Properties (Before Holding Wet Heat)

The heat insulating properties before being held in a constant-temperature and high-humidity bath for 1,000 hours under the environment conditions of a temperature of 85° C. and relative humidity of 85% was evaluated using the following method.

Reflection spectra of the heat insulating glasses of the examples and the comparative examples were measured at a wavelength in a range of 5 μm to 25 μm by using an infrared spectroscope (IFS 66 v/S manufactured by Bruker Optics K.K.). A coefficient of overall heat transmission (U value) was calculated based on JIS A 5759 and the ranking was performed based on the following evaluation standard. The reflectivity at a wavelength of 25 μm to 50 μm was extrapolated from the reflectivity at 25 μm based on JIS A 5759. The coefficient of overall heat transmission (U value) is preferably small, because the heat insulating properties are increased.

<<Evaluation Standard>>

AA: less than 4.8 Wm²·K

A: equal to or greater than 4.8 Wm²·K and less than 5.0 Wm²·K

B: equal to or greater than 5.0 Wm²·K and less than 5.5 Wm²·K

C: equal to or greater than 5.5 Wm²·K and less than 5.9 Wm²·K

The results obtained were shown in the following Table 1 as heat insulating properties (before holding wet heat).

(3) Moisture-heat Resistance of Heat Insulating Properties

The heat insulating properties after being held in a constant-temperature and high-humidity bath for 1,000 hours under the environment conditions of a temperature of 85° C. and relative humidity of 85% was evaluated using the following method.

After holding the heat insulating glasses of the examples and the comparative examples in a constant-temperature and high-humidity bath for 1,000 hours under the environment conditions of a temperature of 85° C. and relative humidity of 85%, a coefficient of overall heat transmission (U value) was measured using the same method as that in the evaluation of the heat insulating properties before holding, and a coefficient of overall heat transmission after holding wet heat was obtained.

A difference between the coefficients of overall heat transmission before and after holding wet heat was calculated and the ranking was performed based on the following evaluation standard.

<<Evaluation Standard>>

AA: a difference between the coefficient of overall heat transmission before holding wet heat and the coefficient of overall heat transmission after holding wet heat is less than 0.1 Wm²·K

A: a difference between the coefficient of overall heat transmission before holding wet heat and the coefficient of overall heat transmission after holding wet heat is equal to or greater than 0.1 Wm²·K and less than 0.3 Wm²·K

B: a difference between the coefficient of overall heat transmission before holding wet heat and the coefficient of overall heat transmission after holding wet heat is equal to or greater than 0.3 Wm²·K and less than 0.5 Wm²·K

C: a difference between the coefficient of overall heat transmission before holding wet heat and the coefficient of overall heat transmission after holding wet heat is equal to or greater than 0.5 Wm²·K

The results obtained were shown in the following Table 1 as moisture-heat resistance of heat insulating properties.

(4) Scratch Resistance

By using a rubbing tester (AB301 manufactured by Tester Sangyo Co., Ltd.) under the environment conditions of a temperature of 25° C. and relative humidity of 60%, steel wool (#0000 manufactured by Nihon Steel Wool Co., Ltd.) was rubbed against the coating surfaces of the heat insulating glasses of the examples and the comparative examples (in Comparative Example 1, the surface of the fibrous conductive particles-containing layer, and in the other examples and comparative examples, the surface of the protective layer) 10 times by applying a load of 200 g at a stroke width of 25 mm and a speed of 30 mm/sec, the surfaces thereof were visually observed, and the ranking was performed based on the following evaluation standard.

<<Evaluation Standard>>

AA: the number of scratches that can be observed from right above is 0 to 5

A: the number of scratches that can be observed from right above is 6 to 10

B: the number of scratches that can be observed from right above is 11 to 20

C: the number of scratches that can be observed from right above is equal to or greater than 21

The results obtained were shown in the following Table 1 as scratch resistance.

The measurement results or evaluation results are shown in the following Table 1.

TABLE 1

| | Binder of fibrous conductive | | | | | | | Heat | Moisture- | |
|---|---|---|---|---|---|---|---|---|---|---|
| | Particles-containing layer | | | Protective layer | | | | insulating | heat | |
| | | Far infrared | Far infrared | | Far infrared | | | properties | resistance | |
| | | ray | ray | | ray | | | (before | of heat | |
| | | reflectivity | transmittance | | transmittance | Film | | holding | insulating | Scratch |
| | Material | (%) | (%) | Material | (%) | thickness | Haze | wet heat) | properties | resistance |
| Example 1 | SiO₂ | 27 | — | COP | 86 | 1 μm | A | A | A | A |
| Example 2 | SiO₂ | 27 | — | COP | 86 | 3 μm | A | A | AA | A |
| Example 3 | SiO₂ | 27 | — | COP | 86 | 7 μm | A | B | AA | AA |
| Example 4 | SiO₂ | 27 | — | PAN | 62 | 1 μm | A | B | A | A |
| Example 5 | PEDOT | 24 | — | COP | 86 | 1 μm | A | B | A | A |
| Example 6 | COP | — | 86 | COP | 86 | 1 μm | A | A | A | A |
| Example 7 | SiO₂ | 27 | — | COP | 86 | 1 μm | A | A | A | A |
| Comparative | SiO₂ | 27 | — | — | — | — | C | AA | C | C |
| Example 1 | | | | | | | | | | |
| Comparative | SiO₂ | 27 | — | PMMA | 42 | 1 μm | A | C | B | AA |
| Example 2 | | | | | | | | | | |
| Comparative | PU | — | 24 | COP | 86 | 1 μm | A | C | A | A |
| Example 3 | | | | | | | | | | |

As described above, it was found that the heat insulating film of the invention is manufactured at a low manufacturing cost and satisfies both low haze and high heat insulating properties.

Meanwhile, it was found from Comparative Example 1, that haze is deteriorated, in a case of not providing a protective layer.

It was found from Comparative Example 2, that heat insulating properties are deteriorated, in a case where a material in which an average transmittance for far infrared rays at a wavelength of 5 μm to 10 μm in conversion of film thickness as 20 μm is lower than a low limit value defined in the invention is used as a main component of a protective layer.

It was found from Comparative Example 3, that heat insulating properties are deteriorated, in a case where a material in which a maximum peak value of reflectivity for far infrared rays at a wavelength of 5 to 25 μm is lower than a low limit value defined in the invention and an average transmittance for far infrared rays at a wavelength of 5 μm to 10 μm in conversion of film thickness as 20 μm is lower than a low limit value defined in the invention is used as a main component of a binder of a fibrous conductive particles-containing layer.

According to the preferred aspects of the heat insulating film of the invention, it was found that it is also possible to improve moisture-heat resistance of the heat insulating properties or scratch resistance.

When the heat insulating film of Example 1 was bonded to a window of a building, the consumption of an air conditioner was averagely decreased by 10% during the winter, compared to a case where the heat insulating film was not used.

In addition, when the heat insulating film of Example 1 was bonded to a window of a vehicle, the consumption of an air conditioner was averagely decreased by 15% during the winter.

### INDUSTRIAL APPLICABILITY

The heat insulating glass of the invention using the heat insulating film of the invention satisfies both low haze and high heat insulating properties, and therefore, when, the heat insulating film of the invention is disposed on the inner side of the window, it is possible to provide a window satisfying both low haze and high heat insulating properties. When the heat insulating film of the invention is used, it is possible to provide a building or a vehicle including windows satisfying both low haze and high heat insulating properties. When the heat insulating film is combined with a well-known near infrared shielding layer, the building can allow light on the outdoor side of the window to emit the indoor side thereof and can prevent an increase in temperature on the indoor side due to light irradiation from the outdoor side of the window. Even in a case where light on the outdoor side of the window emits the indoor side over a long time, it is possible to prevent heat exchange from the indoor side to the outdoor side. Thus, the indoor side (the inside of a room or the inside of a car) of a building or a vehicle provided with such windows can be maintained in a desired environment.

Even when the heat insulating film of the invention is bonded to the inside of a well-known window (for example, window of a building or a vehicle), it is possible to provide a window satisfying both low haze and high heat insulating properties.

### EXPLANATION OF REFERENCES

10: support
20: fibrous conductive particles-containing layer
21: protective layer
31: first adhesive layer
32: second adhesive layer
41: near infrared shielding layer
51: pressure sensitive adhesive layer
61: glass
101: adhesive layer-attached support
102: heat insulating member
103: heat insulating film
111: heat insulating glass
IN: indoor side
OUT: outdoor side

What is claimed is:

1. A heat insulating film comprising:
a support;
a fibrous conductive particles-containing layer; and
a protective layer, in this order,
wherein the fibrous conductive particles-containing layer includes a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component, and fibrous conductive particles, and
the protective layer includes a material having an average transmittance for far infrared rays at a wavelength of 5 μm to 10 μm in conversion of a film thickness as 20 μm which is equal to or greater than 50%, as a main component.

2. The heat insulating film according to claim 1,
wherein the main component of the binder of the fibrous conductive particles-containing layer is at least one kind selected from silicon oxide, zirconium oxide, titanium oxide, and aluminum oxide.

3. The heat insulating film according to claim 1,
wherein the main component of the binder of the fibrous conductive particles-containing layer is a conductive polymer.

4. The heat insulating film according to claim 1,
wherein the main component of the binder of the fibrous conductive particles-containing layer is polycycloolefin or polyacrylonitrile.

5. The heat insulating film according to claim 1,
wherein the main component of the protective layer is polycycloolefin or polyacrylonitrile.

6. The heat insulating film according to claim 1,
wherein a film thickness of the protective layer is 0.1 to 5 μm.

7. The heat insulating film according to claim 1,
wherein the main component of the protective layer is a material in which an average transmittance for far infrared rays at a wavelength of 5 μm to 10 μm in conversion of a film thickness as 20 μm is equal to or greater than 70%.

8. The heat insulating film according to claim 1,
wherein an average long axis length of the fibrous conductive particles is 5 to 50 μm.

9. The heat insulating film according to claim 1,
wherein the fibrous conductive particles consist of silver.

10. The heat insulating film according to claim 1,
wherein the heat insulating film is disposed on an inner side of a window, and the fibrous conductive particles-containing layer is disposed on a surface of the support on a side opposite to the surface of the window side.

11. A manufacturing method of a heat insulating film comprising:
applying a coating solution for forming a fibrous conductive particles-containing layer including a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component, and fibrous conductive particles, on a support to form a fibrous conductive particles-containing layer; and
applying a coating solution for forming a protective layer including a material having an average transmittance for far infrared rays at a wavelength of 5 μm to 10 μm in conversion of a film thickness as 20 μm which is equal to or greater than 50%, as a main component, on the fibrous conductive particles-containing layer to form a protective layer.

12. A manufacturing method of a heat insulating film comprising:
applying a coating solution for forming a precursor layer including fibrous conductive particles on a support to form a precursor layer;
applying a coating solution for converting a precursor layer including a binder including a material having a maximum peak value of reflectivity for far infrared rays at a wavelength of 5 to 25 μm which is equal to or greater than 20% or a material having an average transmittance for far infrared rays at a wavelength of 5 μm to 10 μm in conversion of a film thickness as 20 μm which is equal to or greater than 50%, as a main component, on the precursor layer and causing the coating solution to permeate the precursor layer to form a fibrous conductive particles-containing layer; and
applying a coating solution for forming a protective layer including a material having an average transmittance for far infrared rays at a wavelength of 5 μm to 10 μm in conversion of a film thickness as 20 μm which is equal to or greater than 50%, as a main component, on the fibrous conductive particles-containing layer to form a protective layer.

13. A heat insulating glass in which the heat insulating film according to claim 1 and a glass are laminated.

14. A window comprising:
a transparent window support; and
the heat insulating film according to claim 1 bonded to the transparent window support.
